(19) United States
(12) Patent Application Publication
(10) Pub. No.: US 2026/0226998 A1
(43) Pub. Date: Aug. 6, 2026

(54) SLAM-SHUT VALVES AND CONTROLLER DEVICES FOR SLAM-SHUT VALVES

(71) Applicant: EMERSON PROCESS MANAGEMENT REGULATOR TECHNOLOGIES, INC., McKinney, TX (US)

(72) Inventor: Tung K. Nguyen, McKinney, TX (US)

(21) Appl. No.: 19/465,850

(22) Filed: Jan. 30, 2026

Related U.S. Application Data
(60) Provisional application No. 63/752,323, filed on Jan. 31, 2025.

(51) Int. Cl. F16K 31/122; F16K 1/12; F16K 1/52

(52) U.S. Cl. CPC F16K 31/1221; F16K 1/126; F16K 1/52

(57) ABSTRACT

Slam-shut valves and controllers for slam-shut valves. An exemplary controller includes a controller body including a first port and a second port, the first port adapted to be in fluid communication with a pressure downstream of the slam-shut device, and the second port adapted to be in fluid communication with an actuator outlet of the slam-shut device. The controller also includes a control element, a controller sleeve disposed in the controller body, the controller sleeve comprising a sleeve port configured to be in fluid communication with the second port of the controller body, and a controller seat at least partially disposed within the controller body. The control element is movable within the controller body relative to the controller seat between a first position and a second position responsive to a downstream overpressure condition or underpressure condition detected via the first port, thereby closing the slam-shut device via the second port.

### CROSS-REFERENCE TO RELATED APPLICATION

The present application claims the priority benefit of U.S. Provisional Patent Application No. 63/752,323, filed January 31, 2025, and titled “SLAM-SHUT VALVES AND CONTROLLER DEVICES FOR SLAM-SHUT VALVES,” the entire disclosure of which is hereby incorporated by reference herein.

### FIELD OF THE DISCLOSURE

The present disclosure generally relates to slam-shut valves, and, more particularly, to slam-shut valves and controller devices for slam-shut valves.

### BACKGROUND OF THE INVENTION

Gas distribution systems, such as systems used to distribute natural gas, typically transport gas from a producer to a consumer along a series of pipes and through a series of valves. Each gas distribution system may include one or more regulator valves that control the pressure of the gas within the distribution system. Normally, the gas is transmitted at a high pressure through the system. However, the pressure of the gas must be reduced prior to final distribution to the consumers. This pressure reduction is typically accomplished at pressure-reducing stations within local networks.

Typically, these pressure-reducing stations include one or more pressure regulating valves (which may be referred to herein as “regulators” or “main regulators”) and some sort of safety device to shut off the flow of gas should the pressure regulating valve fail. Most commonly, slam-shut safety valves are used for this purpose. For example, U.S. Patent No. 4,134,421 discloses a slam-shut safety valve that provides overpressure protection in a pipeline. Another example of a slam-shut safety valve is disclosed in U.S. Patent No. 8,225,812. The slam-shut safety valve is generally disposed upstream of the pressure regulating valve so that the slam-shut valve may prevent gas from reaching the pressure regulating valve in the event the pressure regulating valve has failed. The slam-shut safety valve monitors gas pressure downstream of the pressure regulating valve. If the downstream pressure deviates from a predetermined range (i.e., is above an upper pressure limit or below a lower pressure limit), the slam-shut safety valve closes, cutting off the flow of gas to the pressure regulating valve and preventing uncontrolled gas pressures downstream of the pressure-reducing station as a result of the pressure regulating valve failure.

### BRIEF SUMMARY OF THE INVENTION

In accordance with a first exemplary aspect of the present invention, a slam-shut device is provided. The slam-shut device includes a valve body comprising a valve inlet, a valve outlet, and a valve fluid flow passageway connecting the valve inlet to the valve outlet, and a valve trim assembly. The valve trim assembly includes a valve seat disposed in the valve fluid flow passageway of the valve body, and a valve plug movable relative to the valve seat to control fluid flow through the valve fluid flow passageway. The valve plug includes a plug body having first end and a second end opposite the first end, a plug plate disposed in the plug body between the first end and the second end, a balancing port formed through the plug plate and fluidly connecting the first end and the second end, a ledge disposed immediately adjacent the first end, and a plug groove formed between the plug plate and the ledge. The valve trim assembly also includes a piston including a piston body having a first end and a second end opposite the first end, a ledge disposed immediately adjacent the first end, and a piston groove formed in the piston body, the piston groove partially defined by the ledge. The valve trim assembly further includes a valve stem coupled to the valve plug and to the piston, the valve stem having a first end and a second opposite the first end, the first end securely disposed in the plug groove, and the second end securely disposed in the piston groove. The slam-shut device further includes an actuator coupled to the valve body, the actuator including a piston chamber, wherein the piston is movably disposed in the piston chamber, and a spring having one end seated against the piston and the other end seated against the actuator, the spring configured to bias the valve plug relative to the valve seat.

In accordance with a second exemplary aspect of the present invention, a controller for a slam-shut device is provided. The controller includes a controller body including a first port and a second port, the first port adapted to be in fluid communication with a pressure downstream of the slam-shut device, and the second port adapted to be in fluid communication with an actuator outlet of the slam-shut device. The controller also includes a control element, a controller sleeve disposed in the controller body, the controller sleeve including a sleeve port configured to be in fluid communication with the second port of the controller body, and a controller seat at least partially disposed within the controller body. The control element is movable within the controller body relative to the controller seat between a first position and a second position responsive to a downstream overpressure condition or underpressure condition detected via the first port, thereby closing the slam-shut device via the second port.

In accordance with a third exemplary aspect of the present invention, a slam-shut device assembly is provided. The slam-shut device assembly includes a slam-shut valve that includes a valve body comprising a valve inlet, a valve outlet, and a valve fluid flow passageway connecting the valve inlet to the valve outlet, and a valve trim assembly, including: a valve seat disposed in the valve fluid flow passageway of the valve body; a valve plug movable relative to the valve seat to control fluid flow through the valve fluid passageway, the valve plug including a plug body and a plug groove formed in the plug body; a piston including a piston body and a piston groove formed in the piston body; and a valve stem coupled to the valve plug and to the piston, the valve stem having a first end and a second opposite the first end, the first end securely disposed in the plug groove, and the second end securely disposed in the piston groove. The slam-shut device assembly further includes an actuator coupled to the valve body, the actuator including a piston chamber, wherein the piston is movably disposed in the piston chamber, a spring configured to bias the valve plug relative to the valve seat, and a controller coupled to the slam-shut device for selectively closing the slam-shut device. The controller includes: a controller body comprising a first port and a second port, the first port adapted to be in fluid communication with a pressure downstream of the slam-shut device, and the second port adapted to be in fluid communication with an actuator outlet of the slam-shut device; a control element; a controller sleeve disposed in the controller body, the controller sleeve including a sleeve port adapted to be in fluid connection with the second port of the controller body; and a controller seat coupled to the controller body. The control element is movable within the controller body relative to the controller seat between a first position and a second position responsive to an overpressure condition or underpressure condition detected via the first port, thereby closing the slam-shut device via the second port.

In further accordance with any one or more of the first, second, or third exemplary aspects of the present disclosure, the control valve can further include, in any combination, any one or more of the following preferred forms.

In accordance with one preferred form, the spring is configured to bias the valve plug into contact with the valve seat.

In accordance with another preferred form, a relief valve is removably coupled to the actuator, the relief valve configured to selectively relieve the piston chamber.

In accordance with another preferred form, an actuator inlet is at least partially formed in the actuator and an actuator is fluidly connected to the piston chamber via the actuator inlet.

In accordance with another preferred form, a controller stem is movably disposed in the controller body and coupled to the control element to move the control element between the first position and the second position.

In accordance with another preferred form, in one of the first and second positions the control element is engaged with the controller seat and in the other of the first and second positions the control element is spaced apart from the controller seat.

In accordance with another preferred form, the controller stem is movably disposed in the controller body, and the control element includes a disc coupled to an end of the controller stem.

In accordance with another preferred form, the control element comprises a spring coupled to the controller sleeve and the controller seat.

In accordance with another preferred form, the controller sleeve is movable within the controller body relative to the controller seat between a first position and a second position responsive to the downstream overpressure condition or underpressure condition.

In accordance with another preferred form, in one of the first and second positions the controller sleeve is engaged with the controller seat and in the other of the first and second positions the controller sleeve is spaced apart from the controller seat.

In accordance with another preferred form, a controller plug is coupled to the controller sleeve. The controller seat can be integrally formed with the controller plug.

In accordance with another preferred form, in one of the first and second positions the controller sleeve is engaged with the controller seat and in the other of the first and second positions the controller sleeve is spaced apart from the controller seat.

In accordance with another preferred form, the controller seat is carried by the controller sleeve.

In accordance with another preferred form, the spring is configured to bias the valve plug into contact with the valve seat.

In accordance with another preferred form, a relief valve is coupled to the actuator, the relief valve configured to selectively relieve the piston chamber.

In accordance with another preferred form, the relief valve has a body, a seat, an arm movable relative to the seat within the body, and a plug carried by an end of the arm. The relief valve is movable between a first position, in which the plug of the relief valve is seated against the seat of the relief valve, and a second position, in which the plug of the relief valve is spaced from the seat of the relief valve, thereby relieving the piston chamber.

In accordance with another preferred form, the controller sleeve is movable within the controller body between a first position and a second position responsive to an overpressure condition or underpressure condition in the first port.

In accordance with another preferred form, the controller further includes a controller plug coupled to the controller sleeve. The controller seat can be integrally formed with the controller plug.

### BRIEF DESCRIPTION OF THE DRAWINGS

FIG. 1 is a cross-sectional view of a known slam-shut valve, showing a valve plug of the known valve in an open position.

FIG. 2 is similar to FIG. 1 but shows the pressure distribution when the valve plug is in a closed position.

FIG. 3A is a perspective view of a first example of a slam-shut valve employing a first example of a pressure trim assembly constructed in accordance with the teachings of the present disclosure.

FIG. 3B is another perspective view of the first example of the slam-shut valve but rotated relative to the perspective view of FIG. 3A.

FIG. 4 is a cross-sectional view of FIG. 3A, showing a valve plug of the pressure trim assembly in an open position.

FIG. 5A is an exploded view of the valve plug.

FIG. 5B is a perspective view of the valve plug.

FIG. 5C is a cross-sectional view of the valve plug.

FIG. 5D is similar to FIG. 5C but with the sealing elements of the valve plug removed.

FIG. 5E is a cross-sectional view taken along line 5-5 in FIG. 5D.

FIG. 5F is a perspective view of FIG. 5E.

FIG. 6A is an exploded view of a piston and an actuator stem of the pressure trim assembly.

FIG. 6B is a perspective view of the piston.

FIG. 6C is a cross-sectional view of the piston and the actuator stem when coupled to the piston.

FIG. 6D is a cross-sectional view of the piston.

FIG. 6E is a cross-sectional view taken along line 6-6 in FIG. 6D.

FIG. 6F is a perspective view of FIG. 6E.

FIG. 7 is an exploded view showing how the valve plug, the piston, and a valve stem of the pressure trim assembly are connected together.

FIG. 8A is a perspective view of the actuator stem.

FIG. 8B is an exploded view of a guide plate of the pressure trim assembly.

FIG. 8C is a cross-sectional view of the guide plate.

FIG. 9A is an exploded view of a plug cap of the pressure trim assembly.

FIG. 9B is a cross-sectional view of the plug cap.

FIG. 10 is a cross-sectional view of the valve plug disposed in the plug cap.

FIG. 11 is similar to FIG. 4, but shows the valve plug in a closed position.

FIG. 12 illustrates the slam-shut valve of FIGS. 3-11 coupled to one example of a ball valve and a first example of a controller constructed in accordance with the teachings of the present disclosure.

FIG. 13 is a cross-sectional view of a second example of a slam-shut valve that is constructed in accordance with the teachings of the present disclosure and includes the pressure trim assembly.

FIG. 14 is a cross-sectional view of a third example of a slam-shut valve employing another example of a pressure trim assembly constructed in accordance with the teachings of the present disclosure.

FIG. 15 is a cross-sectional view of a fourth example of a slam-shut valve constructed in accordance with the teachings of the present disclosure, showing the valve in an open position.

FIG. 16A is a cross-sectional view of the slam-shut valve of FIG. 15, showing the valve in a closed position.

FIG. 16B is a close-up view of a portion of the slam-shut valve of FIG. 15, showing a relief valve that is coupled to the slam-shut valve and is in a first position.

FIG. 16C is similar to FIG. 16B but shows the relief valve in a second position.

FIG. 16D is a perspective view of the relief valve.

FIG. 17 is a cross-sectional view of a second example of a controller constructed in accordance with the teachings of the present disclosure, showing the controller in a closed position.

FIG. 18 is similar to FIG. 17 but shows the controller in an open position.

FIG. 19 is an exploded view of the controller of FIGS. 17-18.

FIG. 20 is a cross-sectional view of a first example of a slam-shut assembly that is constructed in accordance with the teachings of the present disclosure and includes the slam-shut valve of FIGS. 15-16 coupled to the controller of FIGS. 17-19, showing the slam-shut valve in an open position and the controller in a closed position.

FIG. 21 is similar to FIG. 20 but shows the slam-shut valve in a closed position and the controller in an open position.

FIG. 22 is a cross-sectional view of a third example of a controller constructed in accordance with the teachings of the present disclosure, showing the controller in a closed position.

FIG. 23 is similar to FIG. 22 but shows the controller in an open position.

FIG. 24 is an exploded view of the controller of FIGS. 22-23.

FIG. 25 is a cross-sectional view of a second example of a slam-shut assembly that is constructed in accordance with the teachings of the present disclosure and includes the slam-shut valve of FIGS. 15-16 coupled to the controller of FIGS. 22-24, showing the slam-shut valve in an open position and the controller in a closed position.

FIG. 26 is similar to FIG. 25 but shows the slam-shut valve in a closed position and the controller in an open position.

FIG. 27 is a cross-sectional view of a fourth example of a controller constructed in accordance with the teachings of the present disclosure, showing the controller in a closed position.

FIG. 28 is similar to FIG. 27 but shows the controller in an open position.

FIG. 29 is an exploded view of the controller of FIGS. 27-28.

FIG. 30 is a cross-sectional view of a third example of a slam-shut assembly that is constructed in accordance with the teachings of the present disclosure and includes the slam-shut valve of FIGS. 15-16 coupled to the controller of FIGS. 27-29, showing the slam-shut valve in an open position and the controller in a closed position.

FIG. 31 is similar to FIG. 30 but shows the slam-shut valve in a closed position and the controller in an open position.

FIG. 32 is a cross-sectional view of a fifth example of a controller constructed in accordance with the teachings of the present disclosure, showing the controller in a closed position.

FIG. 33 is similar to FIG. 32 but shows the controller in an open position.

FIG. 34 is an exploded view of the controller of FIGS. 32-33.

FIG. 35 is a cross-sectional view of a fourth example of a slam-shut assembly that is constructed in accordance with the teachings of the present disclosure and includes the slam-shut valve of FIGS. 15-16 coupled to the controller of FIGS. 32-34, showing the slam-shut valve in an open position and the controller in a closed position.

FIG. 36 is similar to FIG. 35 but shows the slam-shut valve in a closed position and the controller in an open position.

FIG. 37 is a cross-sectional view of a sixth example of a controller constructed in accordance with the teachings of the present disclosure, showing the controller in a closed position.

FIG. 38 is similar to FIG. 37 but shows the controller in an open position.

FIG. 39 is an exploded view of the controller of FIGS. 37-38.

FIG. 40 is a cross-sectional view of a fifth example of a slam-shut assembly that is constructed in accordance with the teachings of the present disclosure and includes the slam-shut valve of FIGS. 15-16 coupled to the controller of FIGS. 37-39, showing the slam-shut valve in an open position and the controller in a closed position.

FIG. 41 is similar to FIG. 40 but shows the slam-shut valve in a closed position and the controller in an open position.

### DETAILED DESCRIPTION OF THE INVENTION

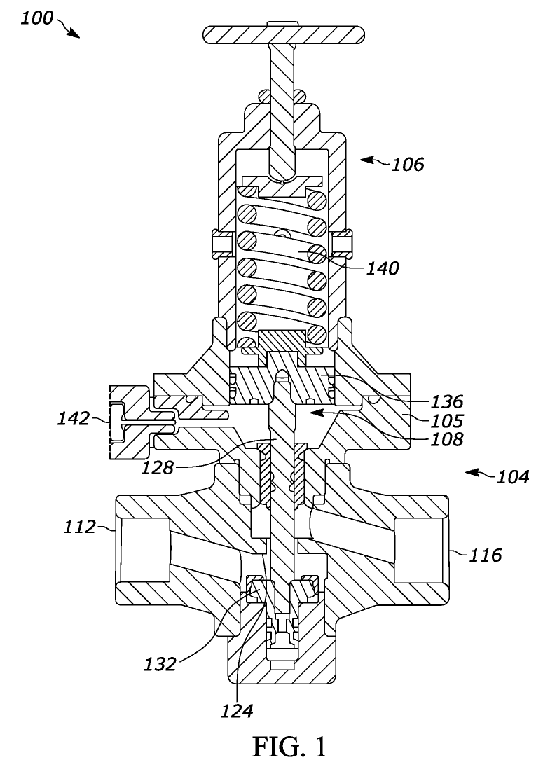

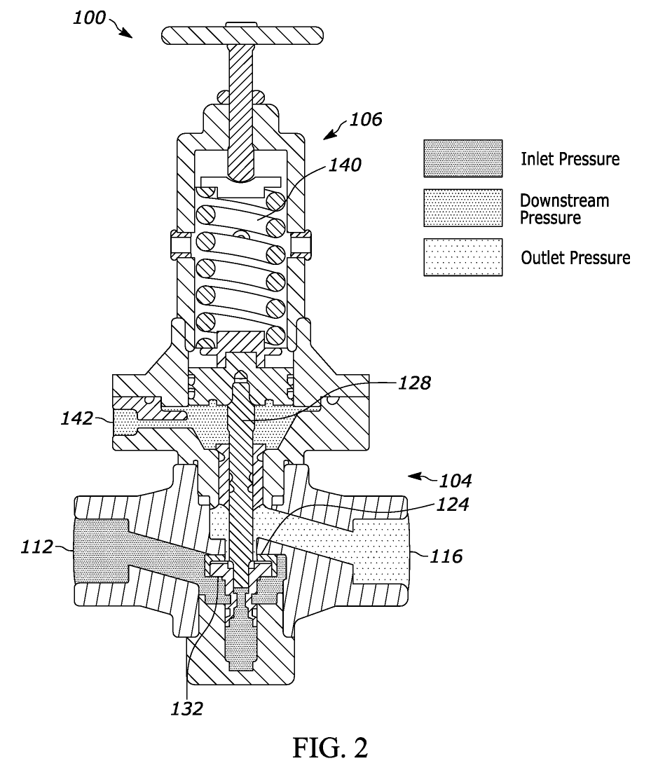

FIGS. 1 and 2 illustrate one known example of a slam-shut valve 100. As illustrated, the slam-shut valve 100 includes a valve body 104, a valve bonnet 105 coupled to the valve body 104, a spring case 106 coupled to the valve bonnet 105, and a trim assembly 108 arranged in the valve body 104, the valve bonnet 105, and the spring case 106. The valve body 104 defines an inlet 112 and an outlet 116 connected by fluid flow passageway 120. The trim assembly 108 includes a valve seat 124, a valve stem 128, a valve plug 132, a piston 136, and a spring 140. The valve seat 124 is arranged in the fluid flow passageway 120. The valve stem 128 has a first end threaded to the valve plug 132 and a second end threaded to the piston 136. The valve plug 132 movably interacts with the valve seat 124 to control fluid flow through the fluid flow passageway 120. The piston 136 is movably disposed in the valve bonnet 105. The spring 140 is disposed in the spring case 106 and configured to bias a top of the piston 136 in a direction toward the valve seat 124.

The piston 136 is movable responsive to the downstream pressure, which is fluidly coupled to the valve bonnet 105 (and more particularly the piston 136) via a port 142 formed in the valve bonnet 105. When the downstream pressure deviates from a predetermined range (e.g., is above an upper pressure limit), the downstream pressure applies a force on a bottom of the piston 136 that exceeds the biasing force applied by the spring 140, the piston 136 moves upward (at least in this orientation), causing the valve stem 128 to move upward (at least in this orientation). Upward movement of the valve stem 128 causes the valve plug 132 to move toward and into contact with the valve seat 124, thereby shutting off fluid flow through the fluid flow passageway 120, as illustrated in FIG. 2, and closing the slam-shut valve 100. Conversely, when the downstream pressure is within the predetermined range, the force applied by the downstream pressure on the bottom of the piston 136 is less than the biasing force applied by the spring 140, the piston 136 moves downward (at least in this orientation), causing the valve stem 128 to move downward (at least in this orientation). Downward movement of the valve stem 128 causes the valve plug 132 to move out of contact and away from the valve seat 124, thereby allowing fluid flow through the fluid flow passageway 120, as illustrated in FIG. 1, and opening (or keeping open) the slam-shut valve 100.

The known slam-shut valve 100 suffers from several problems, however. First, because the valve plug 132 is unbalanced, when the valve plug 132 is seated against the valve seat 124, as is illustrated in FIG. 2, the first side of the valve plug 132 is subjected to a first force generated by the pressure at the outlet 116 and the second side of the valve plug 132 is subjected to a second force generated by the pressure at the inlet 112 that is different from the first force. In other words, the first and second sides of the valve plug 132 are subjected to different forces, with the exact value of this pressure differential dependent upon the working conditions of the known slam-shut valve 100 (i.e., the pressure at the inlet 112 and the pressure at the outlet 116 during operation). In turn, the spring 140 must be specifically designed to meet the working conditions needed for the particular application in which the known slam-shut valve 100 is employed. More particularly, the spring 140 must be specifically designed to provide the proper biasing force necessary to accommodate the working conditions of the known slam-shut valve 100. But when the working conditions change (e.g., when the pressure at the outlet 116 increases or decreases), the closing force required to keep the valve plug 132 closed (i.e., in contact with the valve seat 120) changes as well. In turn, the spring 140 may need to be adjusted or removed and replaced with a different spring 140 that is more suited for the changed working conditions. And because the working conditions often vary, many different types of springs 140 must be specifically designed for use with the known slam-shut valve 100.

Second, because the valve stem 128, the valve plug 132, and the piston 136 are rigidly connected (via threaded connections), the concentricity tolerance of each of the valve stem 128, the valve plug 132, and the piston 136 will have to be superimposed during manufacture. In other words, the valve stem 128, the valve plug 132, and the piston 136 have tighter geometrical tolerance requirements. This, in turn, increases the difficulty and cost of manufacturing these components and increases the friction between the trim assembly 108 and the valve body 104 and the bonnet 105 during operation of the known slam-shut valve 100, which in turn reduces the accuracy of the known slam-shut valve 100.

The present disclosure is directed to a pressure trim assembly that addresses these problems with the known slam-shut valve 100 (and other known slam-shut valves) as well as other problems with known valves. Like the trim assembly 108 of the known slam-shut valve 100, the pressure trim assembly of the present disclosure generally includes a valve seat, a valve stem, a valve plug, and a piston. However, the pressure trim assembly of the present disclosure is structurally and functionally different from the trim assembly 108 in several important ways.

Importantly, the pressure trim assembly of the present disclosure is designed so that the valve plug of the pressure trim assembly is balanced. Thus, when the pressure trim assembly is employed in a slam-shut valve having a valve body, and when the valve plug is seated against the valve seat, the first side of the valve plug is subjected to a first force and the second side is subjected to a second force that is equal (or substantially equal) to the first force. This is true regardless of, for example, the exact pressures at the outlet and the inlet of the valve body. In other words, the closing force required to maintain the valve plug seated against the valve seat is independent of the pressure at the inlet and/or the pressure at the outlet, which is particularly beneficial when the slam-shut valve is utilized for high-pressure fluids. This also allows the pressure trim assembly to employ the same spring regardless of the specific working conditions needed for the particular application in which the slam-shut valve is employed.

Moreover, in the pressure trim assembly of the present disclosure, the valve stem, the valve plug, and the piston are connected to one another in a less rigid manner than utilized in the known slam-shut valve 100 (and other known valves). More particularly, the valve stem, the valve plug, and the piston are connected to one another utilizing two U-shaped, segmented connections. The U-shaped, segmented connections have significantly less geometrical tolerance requirements than, for example, the rigid connections employed in the known slam-shut valve 100. In turn, the valve stem, the valve plug, and the piston are easier and less expensive to manufacture and to assemble. The use of U-shaped, segmented connections also reduces the friction between the components of the pressure trim assembly and the valve body when the pressure trim assembly is employed in the slam-shut valve and when the slam-shut valve is in operation. This, in turn, increases the accuracy of the slam-shut valve that employs the pressure trim assembly.

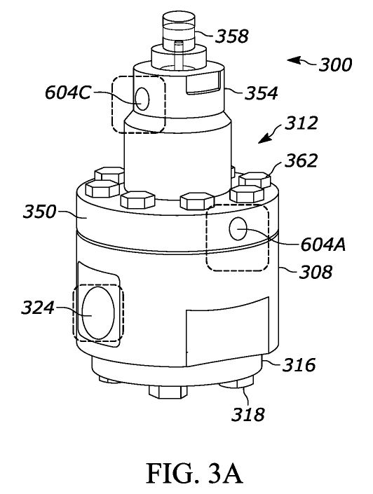

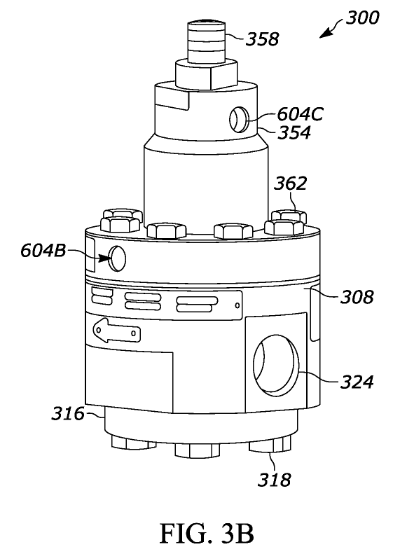

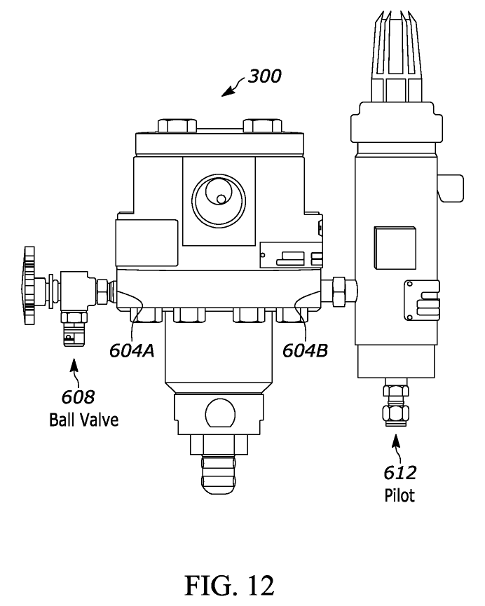

FIGS. 3A-12 Illustrate one example of a valve 300 that employs a pressure trim assembly 304 constructed in accordance with the teachings of the present disclosure. The valve 300 in this example is a slam-shut valve that includes a valve body 308, an actuator 312 coupled to the valve body 308, and the pressure trim assembly 304, which is movably arranged within the valve body 308 and the actuator 312. The slam-shut valve 300 in this example also includes an annular flange 316 coupled to the valve body 308 (e.g., via a plurality of fasteners 318) to help retain components of the pressure trim assembly 304 within the valve body 308. In other examples, however, the slam-shut valve 300 may be a rotary valve or other type of valve and/or may include different, additional, or fewer components.

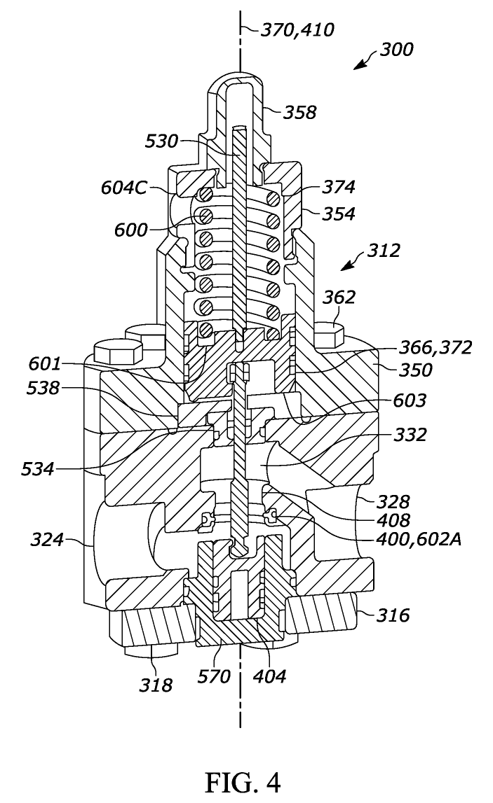

As best illustrated in FIGS. 3A, 3B, and 4, the valve body 308 includes a fluid inlet 324, a fluid outlet 328, and a fluid flow passageway 332 extending between and in fluid communication with the fluid inlet 324 and the fluid outlet 328. As also best illustrated in FIGS. 3A, 3B, and 4, the actuator 312 includes a valve bonnet 350 coupled to the valve body 308, a spring case 354 coupled to the valve bonnet 350, and a cover 358 coupled to the spring case 354. In this example, the valve bonnet 350 is directly coupled to the valve body 308 (e.g., via a plurality of fasteners 362) and defines a central bore 366 that extends along a central axis 370 of the actuator 312. Similarly, the spring case 354 is directly coupled to the valve bonnet 350 and also defines a central bore 374 that extends along the central axis 370. Thus, at least in this example, the central bore 374 is co-axial with the central bore 366, and together the central bore 366 and the central bore 374 define a piston chamber 372. In this example, the spring case 354 is threaded to the valve bonnet 350 via one or more external threads that are arranged on a lower outer surface of the spring case 354 and matingly engage one or more internal threads arranged on an upper inner surface of the valve bonnet 350. In other examples, however, the spring case 354 can be coupled to the valve bonnet 350 in a different manner. Finally, in this example the cover 358 is threaded to the spring case 354 via one or more external threads that are arranged on an outer lower surface of the cover 358 and matingly engage one or more internal threads arranged on an upper internal surface of the spring case 354. In other examples, however, the cover 358 can be coupled to the spring case 354 in a different manner. In any event, when the cover 358 is coupled to the spring case 354, the cover 358 extends upward from the spring case 354 (at least in the orientation shown in FIG. 4) and substantially closes the central bores 366, 374 (and the piston chamber 372).

The pressure trim assembly 304 includes a valve seat 400 and a valve plug 404. The valve seat 400, which in this example is a seat ring, is disposed in an annular port 408 formed in the fluid flow passageway 332. In this example, the valve seat 400 is removably disposed in the valve body 308 and retained therein by a portion of the pressure trim assembly 304. In this example, the valve seat 400 is made of PFTE. In other examples, however, the valve seat 400 can, in other examples, be fixedly disposed (e.g., welded) in the valve body 308 and/or made of a different material. In any event, when the valve seat 400 is disposed in the annular port 408, the valve seat 400 is centered about a central axis 410 of the valve body 308 that is co-axial with the central axis 370. And when the rest of the pressure trim assembly 304 is disposed in the valve body 308, the valve plug 404 is generally movable, along the axis 410, relative to the valve seat 400 to control fluid flow through the slam-shut valve 300. More particularly, the valve plug 404 is movable, along the axis 410, between the fully open position shown in FIG. 4, in which the valve plug 404 is spaced a maximum distance from the valve seat 400, and the closed position shown in FIG. 11, in which the valve plug 404 is seated against the valve seat 400.

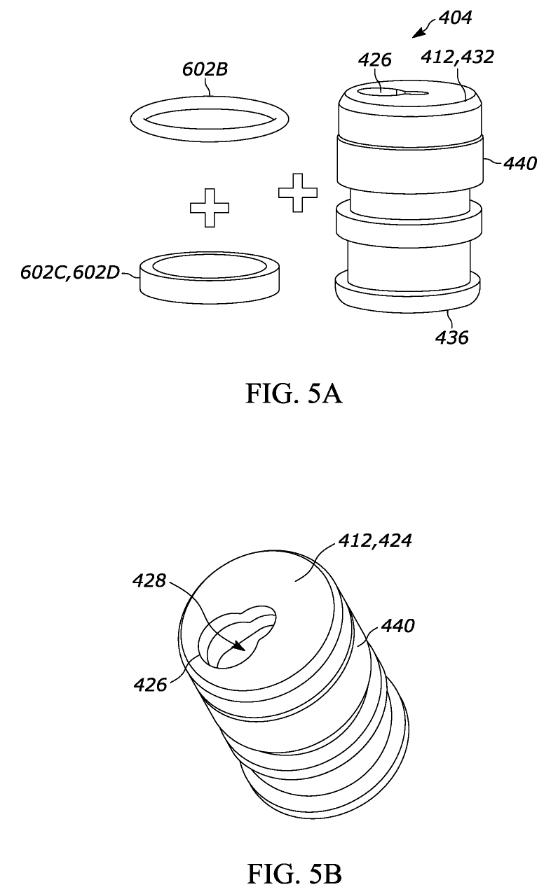

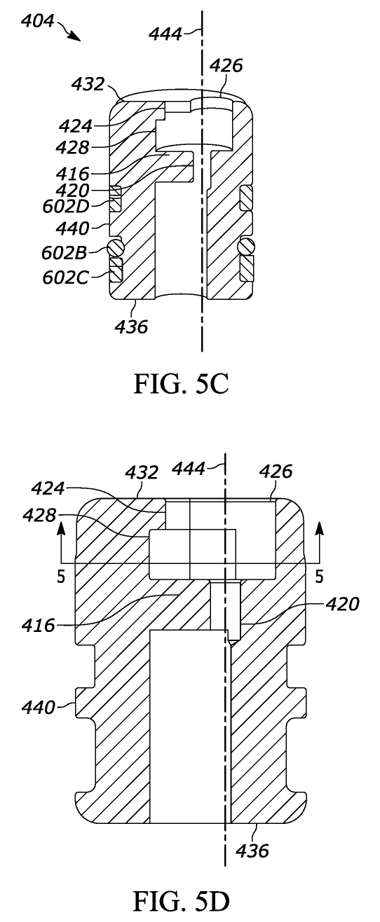

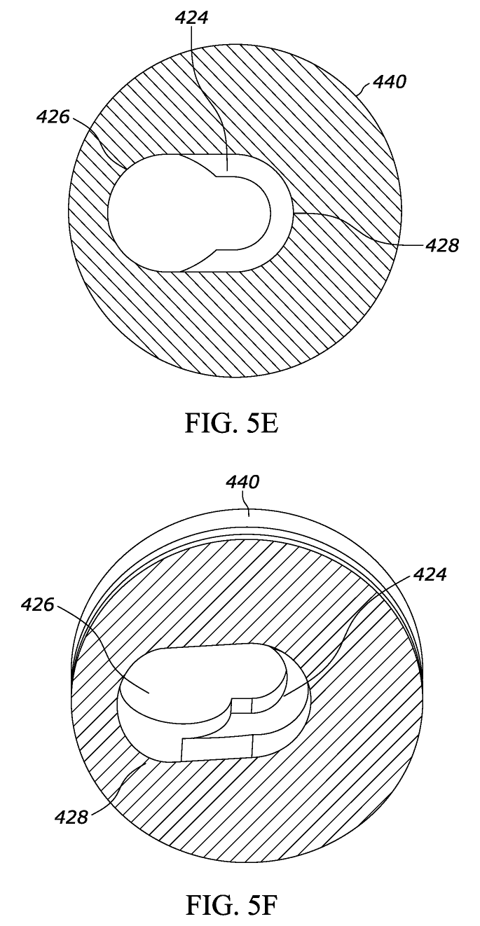

As best illustrated in FIGS. 5A, 5B, 5C, and 5D, the valve plug 404 generally includes a plug body 412, a plug plate 416, and a balancing port 420. The plug body 412 has a first end 432, a second end 436 opposite the first end 432, and a substantially cylindrical wall 440 that extends between the first end 432 and the second end 436. The plug plate 416 is disposed in the plug body 412 between the first end 432 and the second end 436. In this example, the plug plate 416 is an annular plate that is disposed in the plug body 412 at a position closer to the first end 432 than the second end 436. In other examples, however, the plug plate 416 can be positioned at or immediately adjacent to the first end 432 or closer to the second end 436 than the first end 432. The balancing port 420 is formed through the plug plate 416 and fluidly connects the first end 432 and the second end 436. In other words, the first end 432 is fluidly connected to the second end 436 (and vice-versa) via the balancing port 420. As will be appreciated by a side-by-side comparison of FIG. 4 and FIGS. 5C-5F, the balancing port 420 in this example extends along an axis 444 that is offset from the central axis 410 (and, thus, the central axis 370).

With reference to FIGS. 5A-5F, the valve plug 404 also generally includes a ledge 424, a plug aperture 426, and a plug groove 428. The ledge 424 is generally disposed adjacent the first end 432 or the second end 436 of the plug body 412. In this example, the ledge 424 is disposed at and extends radially inwardly from the first end 432 of the plug body 412. In other examples, however, the ledge 424 can be spaced from but immediately adjacent the first end 432, disposed at or immediately adjacent the second end 436, or in a different location along the valve plug 404. In this example, the plug aperture 426 is formed in the plug ledge 424 (such that the plug aperture 426 is located at the first end 432 of the plug body 412) and has a lock shape. The plug groove 428 is generally formed or defined between the plug plate 416 and the ledge 424. In this example, the plug groove 428 is defined between the plug plate 416, the ledge 424 (and the aperture 426), and the substantially cylindrical wall 440 at a position between the first end 432 and the balancing port 420, such that the plug groove 428 is a waist-shaped radial groove formed in an interior of the valve plug 404. In other examples, however, the shape of the plug groove 428 can vary and yet still facilitate the intended U-shaped segmented connection. Moreover, like the balancing port 420, in this example the plug groove 428 is centered about an axis that is offset from the central axis 410 (and, thus, the central axis 370). Further yet, the plug groove 428 has a diameter that is greater than a diameter of the balancing port 420. The diameter of the plug groove 428 can be greater or less than a diameter of the plug aperture 426.

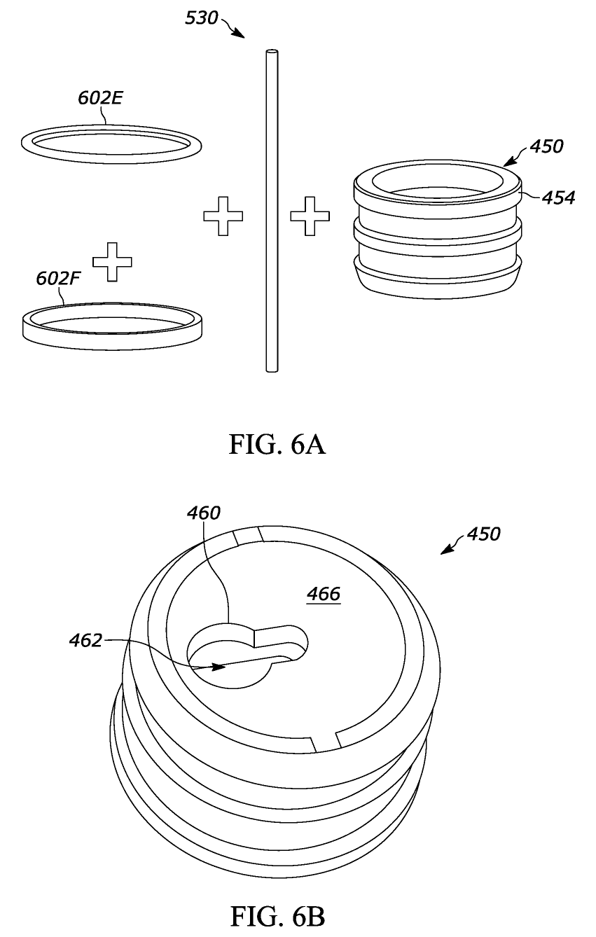

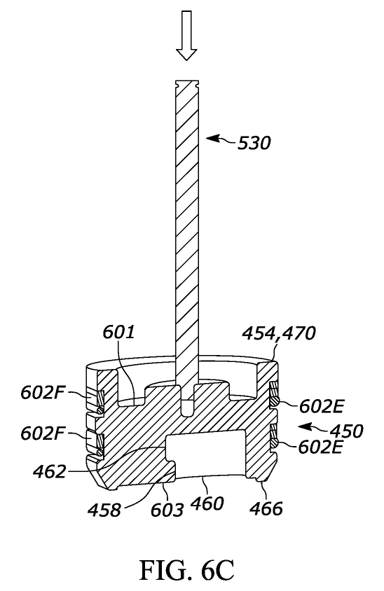

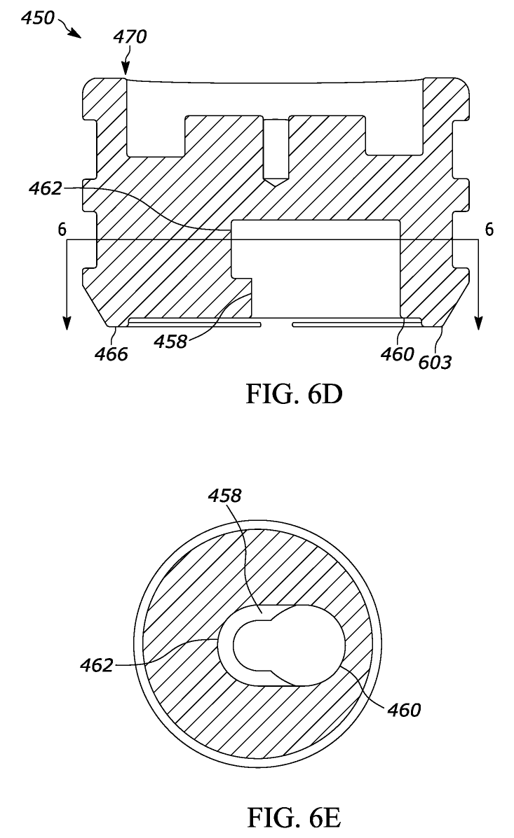

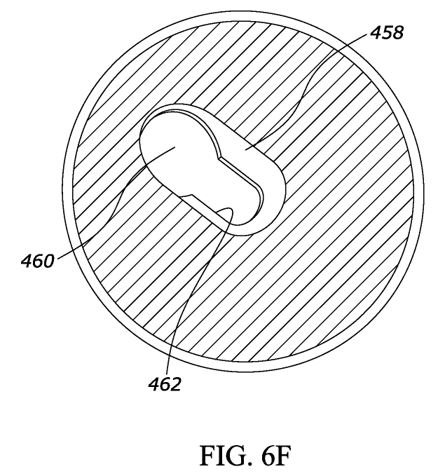

Turning now to FIGS. 6A-6F, the pressure trim assembly 304 also includes a piston 450 that is also movable within the piston chamber 372, along the central axis 370. In this example, the piston 450 has an outer diameter that is larger than an outer diameter of the valve plug 404. The piston 450 generally includes a piston body 454, a piston ledge 458, a piston aperture 460, and a piston groove 462. The piston body 454 has a first end 466 and a second end 470 opposite the first end 466. The ledge 458 is generally disposed adjacent the first end 466 or the second end 470. In this example, the ledge 458 is disposed at and extends radially inwardly from the first end 466 of the piston body 454. In other examples, however, the ledge 458 can be disposed immediately adjacent the first end 466, at or immediately adjacent the second end 470, or in a different location along the piston 450. In this example, the piston aperture 460 is formed in the piston ledge 458 (such that the piston aperture 460 is located at the first end 466 of the piston body 454) and has a lock shape, just like the plug aperture 426. The piston groove 462 is at least partially defined by the ledge 458. In this example, the piston groove 462 is formed in an interior of the piston body 454 such that the piston groove 462 is defined by and between the interior of the piston body 454, the ledge 458 (and the piston aperture 460), and the first end 466 of the piston body 454. In turn, the piston groove 462 is a waste-shaped radial groove that mirrors the shape of the plug groove 428. In other examples, however, the shape of the piston groove 462 can vary and yet still facilitate the intended U-shaped segmented connection. Like the plug groove 428, in this example the piston groove 462 is centered about an axis that is offset from the central axis 370 (and, thus, the central axis 410). It will also be appreciated that the piston groove 462 has a diameter that can be less or greater than a diameter of the piston aperture 460.

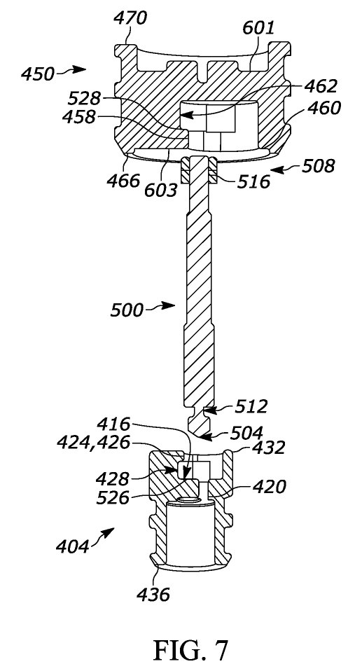

Turning now to FIG. 7, the pressure trim assembly 304 also includes a valve stem 500 that extends and is movable along the central axis 370 and central axis 410. The valve stem 500 has a first end 504 movably disposed in the valve body 308, a second end 508 opposite the first end 504 and movably disposed in the actuator 312, and an outer diameter that is variable between the first end 504 and the second end 508. In this example, the second end 508 is threaded, whereas the first end 504 is not threaded. In other examples, however, the first end 504 can be threaded and/or the second end 508 need not be threaded. The valve stem 500 also has a first annular groove 512 spaced from but immediately adjacent the first end 504. The valve stem 500 further has a second annular groove 516 formed at and immediately adjacent the second (threaded) end 508. In other examples, however, the second annular groove 516 can be spaced from the second end 508.

The valve stem 500 is coupled to both the valve plug 404 and the piston 450. However, consistent with the discussion above, the valve stem 500 is not rigidly coupled to the valve plug 404 or the piston 450. Instead, the valve stem 500 is coupled to the valve plug 404 utilizing a first U-shaped segmented connection, and the valve stem 500 is coupled to the piston 450 utilizing a second U-shaped segmented connection. The first U-shaped segmented connection is generally formed by the interaction between the plug ledge 424, the plug groove 428, the first end 504 of the valve stem 500, and the first annular groove 512. Meanwhile, the second U-shaped segmented connection is generally formed by the interaction between the piston ledge 458, the piston groove 462, the second end 508 of the valve stem 500, and a pair of stem connectors 520 coupled (e.g., threaded) to the second end 508 of the valve stem 500 and retained in the second annular groove 516.

More particularly, as best illustrated in FIG. 7, the first U-shaped segmented connection is formed by (i) axially positioning the first end 504 of the valve stem 500 so that the first end 504 is disposed in and extends through the plug aperture 426 and is disposed in the plug groove 428 and in contact with (or immediately adjacent to) a top side 526 of the plug plate 416, and then (ii) radially positioning the valve plug 404 so that the ledge 424 of the valve plug 404 engages the valve stem 500. Even more particularly, the valve plug 404 is radially positioned so that the ledge 424 of the valve plug 404 is captured in the first annular groove 512. In turn, the first end 504 of the valve stem 500 is entirely disposed in the plug groove 428 and is securely retained therein between the ledge 424 of the valve plug 404 and the top side 526 of the plug plate 416. It will be appreciated that the ledge 424 of the valve plug 404 thus prevents the first end 504 of the valve stem 500 from being inadvertently removed from the plug groove 428. Similarly, the second U-shaped segmented connection is formed by (iii) axially positioning the second end 508 of the valve stem 500 so that the second end 508 is disposed in and extends through the piston aperture 460 and is disposed in the piston groove 462 and in contact with (or immediately adjacent to) the interior of the piston body 452, and then (iv) radially positioning the valve plug 404 so that the ledge 458 of the piston 450 engages a portion of the valve stem 500 directly below the stem connectors 520 and so that the stem connectors 520 disposed in the second annular groove 516 are captured in the piston groove 462. In turn, the second end 508 of the valve stem 500 is entirely disposed in the piston groove 462 and is securely retained therein between the ledge 458 of the piston 450 and the interior of the piston body 452. It will be appreciated that the stem connectors 520 in turn engage a top side 528 of the ledge 458 of the piston 450, which thereby prevents the second end 508 of the valve stem 500 from being inadvertently removed from the piston groove 462. It will also be appreciated that the second U-shaped segmented connection can be formed before or after the first U-shaped segmented connection, depending on how the pressure trim assembly 304 is specifically assembled.

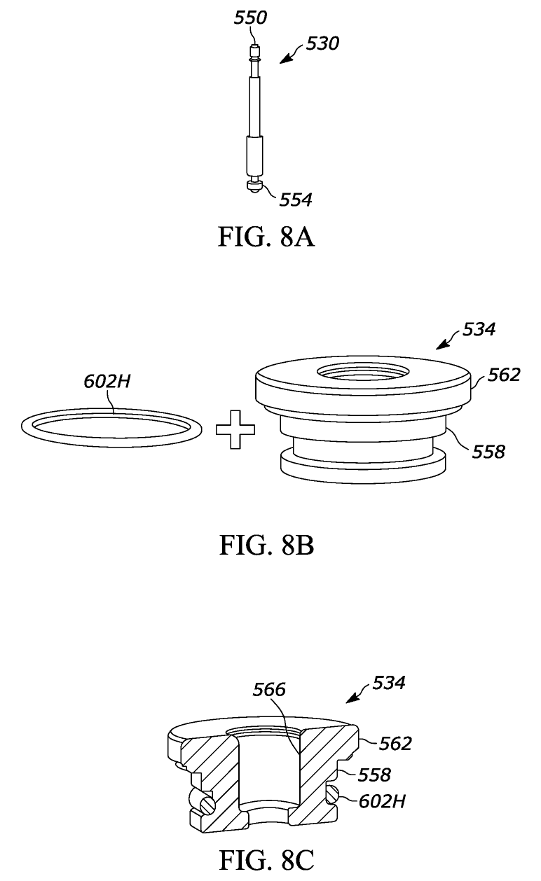

As best illustrated in FIGS. 4 and 8A-8C, the pressure trim assembly 304 further includes an actuator stem 530 and a guide plate 534, and the actuator 312 further includes a bonnet plate 538. The actuator stem 530 is movably disposed in the actuator 312. More particularly, the actuator stem 530 extends and is movable along the central axis 370. The actuator stem 530 has a first end 550 that is coupled to the piston 450 and a second end 554 that is opposite the first end 550 and is movably disposed in the cover 358. The guide plate 534 is configured to facilitate movement of the valve stem 500 in the axial direction (along the central axes 370, 410) but to prevent movement of the valve stem 500 in the radial direction. As best illustrated in FIGS. 8B and 8C, the guide plate 534 in this example has a base 558, a flange 562, and a guide bore 566. The base 558 of the guide plate 534 is disposed in the valve body 308, whereas the flange 562, which extends outward from the base 558, is seated against an exterior surface of the valve body 308. As such, the flange 562 is surrounded by the valve bonnet 350. The guide bore 566 is sized to accommodate the valve stem 500 and to guide the valve stem 500 in the manner described above. The bonnet plate 538, meanwhile, is captured between the valve body 308 and the valve bonnet 350, and, as such, helps to fixedly retain the guide plate 534 in the desired position relative to the valve stem 500. Further, while not explicitly discussed herein, it will be appreciated that one or more bushings may be disposed between the guide plate 534 and the valve stem 500 in order to help retain the valve stem 500 in the desired position relative to the guide plate 534.

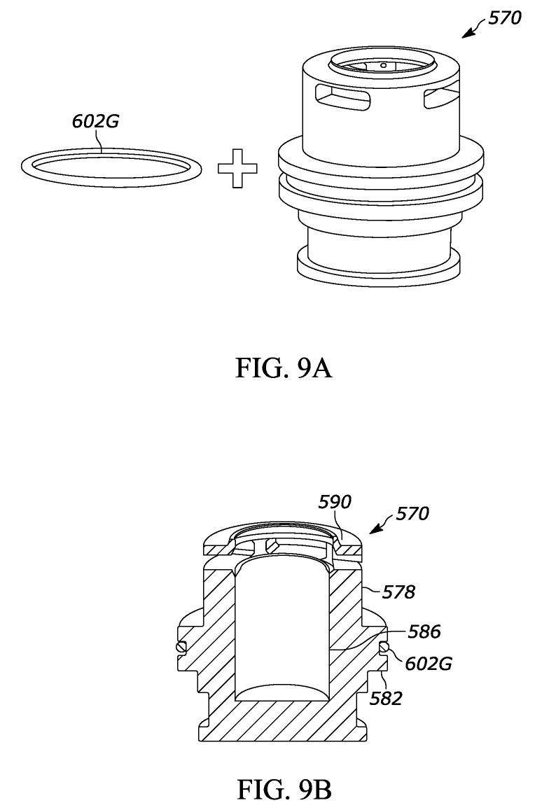

Turning now to FIGS. 9A and 9B, the pressure trim assembly 304 further includes a plug cap 570. The plug cap 570 is generally configured to keep the valve plug 404 in the valve body 308 and to guide movement of the valve plug 404 along the central axis 410. In this example, the plug cap 570 has a base 578, a flange 582, a cap bore 586 defined by the base 578, and a seat retainer 590. The base 578 has a generally U-shape and is sized to be disposed in the valve body 308 and the annular flange 316. The flange 582 is coupled to and extends outward from a central portion of the base 578, such that the flange 582 is positioned to engage a portion of the annular flange 316, which in turn helps to fix the plug cap 570 relative to the valve body 308 and the annular flange 316. The cap bore 586 is generally sized to receive part or all of the valve plug 404 as the valve plug 404 moves relative to the valve seat 400, such that the plug cap 570 partially or entirely surrounds the valve plug 404 (depending upon the exact positioning of the valve plug 404). Finally, the seat retainer 590 is disposed at or immediately adjacent an end of the plug cap 570. Thus, when the plug cap 570 is disposed in the valve body, the seat retainer 590 is positioned to engage the valve seat 400 so as to securely retain the valve seat 400 in the annular port 408 formed in the fluid flow passageway 332.

Turning back to FIG. 4, the pressure trim assembly 304 further includes a spring 600 configured to bias a top side 601 of the piston 450 in a direction toward the valve seat 400. In other words, the spring 600 is configured to bias the valve plug 404 into the open position (in which the valve plug 404 is spaced from the valve seat 400). In this example, the spring 600 is disposed in the actuator 312, with a first end of the spring 600 seated against the piston 450 (and, more particularly, against the top side 601) and a second end of the spring 600 seated against the spring case 354. In other examples, however, the spring 600 can be seated against one or more different components of the actuator 312 and yet still bias the top of the piston 450 in the direction toward the valve seat 400.

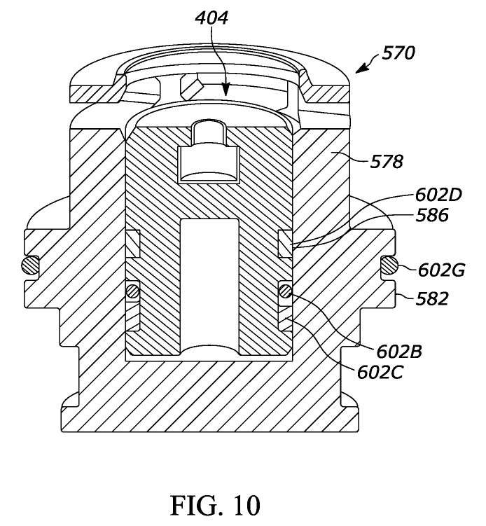

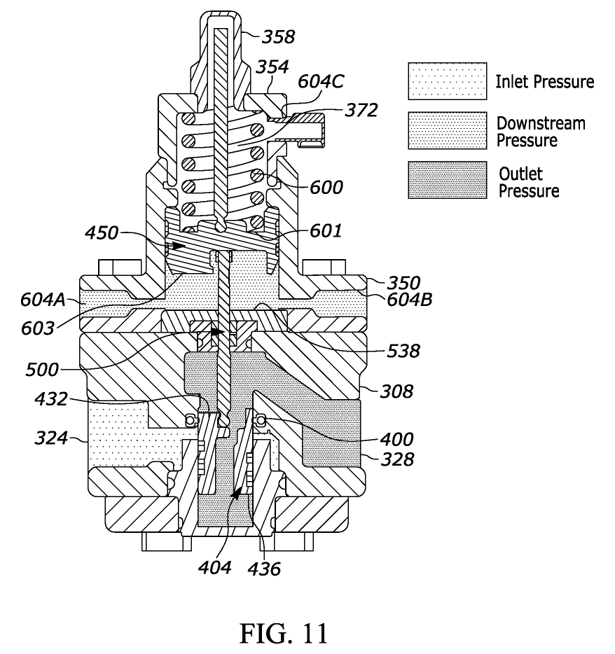

It will be appreciated that the slam-shut valve 300 also includes a plurality of sealing elements arranged to help seal the various components of the slam-shut valve 300. For example, the valve seat 400 includes a sealing element 602A (e.g., an O-ring, a pressure activated seal) that is disposed around an outer surface of the valve seat 400 and sealingly engages a portion of the valve body 308 in the annular port 408 to create a seal between the valve seat 400 and the valve body 308. Meanwhile, the valve plug 404 includes a sealing element 602B (e.g., an O-ring) disposed in a first groove formed in an outer surface of the plug body 412, as well as a pair of back-up rings 602C, 602D also disposed in the first groove and a second groove formed in the outer surface of the plug body 412, as best illustrated in FIGS. 5A and 5C. The sealing element 602B and the back-up rings 602C, 602D are thus positioned to sealingly engage the plug cap 570 to create a seal between the valve plug 404 and the plug cap 570, as best illustrated in FIG. 10. More particularly, the sealing element 602B and the back-up rings 602C, 602D engage an inner surface of the base 578 of the plug cap 570. Likewise, the piston 450 includes a pair of sealing elements 602E (e.g., an O-ring) respectively disposed in first and second grooves formed in an outer surface of the piston body 454, as well as a pair of back-up rings 602F also respectively disposed in the first and second grooves formed in the outer surface of the piston body 454. The sealing elements 602E and the back-up rings 602F are thus positioned to sealingly engage the valve bonnet 350 to create a seal between the piston 450 and the valve bonnet 350. Moreover, the plug cap 570 includes a sealing element 602G (e.g., an O-ring) that is disposed in an outer surface of the flange 582 and configured to sealingly engage a portion of the valve body 308 to create a seal therebetween. The slam-shut valve 300 may also include additional sealing elements, e.g., a sealing element between the valve body 308 and the valve bonnet 350, a sealing element 602H disposed in an outer surface of the guide plate 534 and configured to sealingly engage a portion of the valve body 308 to create a seal therebetween, and one or more sealing elements arranged between the guide plate 534 and the valve stem 500.

It will also be appreciated that the slam-shut valve 300 further includes one or more pressure ports. In this example, the slam-shut valve 300 includes three pressure ports, a first pressure port 604A formed in the valve bonnet 350, a second pressure port 604B also formed in the valve bonnet 350, and a third pressure port 604C formed in the spring case 354, as best illustrated in FIGS. 3A, 3B, 4, 11, and 12. The first pressure port 604A is fluidly coupled to a ball valve 608 located downstream of the slam-shut valve 300, such that the first pressure port 604A is fluidly coupled to downstream pressure (i.e., pressure downstream of the slam-shut valve 300). In turn, the first pressure port 604A facilitates fluid communication between the downstream ball valve 608 and a first portion of the piston chamber 372 defined between a bottom side 603 of the piston 450 and the bonnet plate 538. In other words, the first portion of the piston chamber 372 will be fluidly coupled to the downstream pressure via the first pressure port 604A. The second pressure port 604B is fluidly coupled to a controller 612 also located downstream of the slam-shut valve 300, such that the second pressure port 604B is also fluidly coupled to downstream pressure. In turn, the second pressure port 604B facilitates fluid communication between the controller 612 and the first portion of the piston chamber 372. In other words, the first portion of the piston chamber 372 will also be fluidly coupled to the downstream pressure via the second pressure port 604B (the downstream pressure fluidly coupled to the second pressure port 604B is the same as the downstream pressure fluidly coupled to the first pressure port 604A). On the other hand, the third pressure port 604C facilitates fluid communication with a second portion of the piston chamber 372 defined between the spring case 354 and the top side 601 of the piston 450. The third pressure port 604C is typically fluidly coupled to atmosphere, in which case the second portion of the piston chamber 372 will be fluidly coupled to atmospheric pressure via the third pressure port 604C In other examples, however, the slam-shut valve 300 may only include one pressure port (e.g., the first pressure port 604A), more than three pressure ports, and/or any of the pressure ports can be positioned in a different location. In yet other examples, the first and/or second pressure ports 604A, 604B can be coupled to different pressure sources.

In operation, the piston 450 is movable within the piston chamber 372 responsive to the downstream pressure, which, as discussed above, is fluidly coupled to the piston chamber 372 via the first pressure port 604A and the second pressure port 604B. When the downstream pressure is within a predetermined range (e.g., below an upper pressure limit), the downstream pressure applies a force on the bottom side 603 of the piston (via the first pressure port 604A) that is less than the biasing force applied by the spring 600, the piston 450 moves downward (at least in this orientation), causing the valve stem 500 to move downward (at least in this orientation). Downward movement of the valve stem 500 causes the valve plug 404 to move out of contact and away from the valve seat 400 and into the fully open position (or an intermediate open position), thereby allowing fluid flow through the fluid flow passageway 332, as illustrated in FIG. 4, such that the slam-shut valve 300 is in an open position. Conversely, response to the downstream pressure falling outside of the predetermined range (e.g., being above the upper pressure limit), the force applied by the downstream pressure on the bottom side 603 of the piston 450 exceeds the biasing force applied by the spring 600, the piston 450 moves upward (at least in this orientation), causing the valve stem 500 to move upward (at least in this orientation). Upward movement of the valve stem 500 causes the valve plug 404 to move toward and into contact with the valve seat 400 and into the closed position, thereby shutting off fluid flow through the fluid flow passageway 332, as illustrated in FIG. 11, such that the slam-shut valve 300 is in a closed position. When the valve plug 404 is seated against the valve seat 400, the first end 432 of the plug body 412 is subjected to a force generated by the pressure at the fluid outlet 328. Because the valve plug 404 is balanced, however, the underside of the plug plate 416 and the second end 436 of the plug body 412 are in fluid communication with the first end 432 of the plug body 412 via the plug aperture 426, the plug groove 428, and the balancing port 420. As such, the second end 436 of the plug body 412 (as well as the underside of the plug plate 416) is subjected to that same force (generated by the pressure at the fluid outlet 328). In turn, and consistent with the discussion above, the same spring – the spring 600 – can be used, regardless of the specific working conditions (e.g., the specific pressures at the fluid inlet 324 and/or the fluid outlet 328) associated with the slam-shut valve 300.

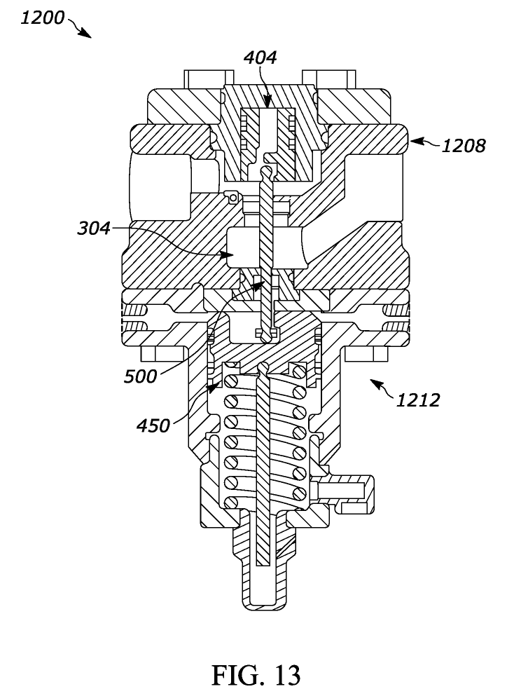

FIG. 13 illustrates another example of a valve 1200 constructed in accordance with the teachings of the present disclosure. The valve 1200 is similar to the valve 300 in that the valve 1200 is also a slam-shut valve that includes a valve body 1208, an actuator 1212, and the pressure trim assembly 304. While the valve body 1208 and the actuator 1212 are similar to the valve body 308 and the actuator 312, respectively, the slam-shut valve 1200 is oriented differently than the slam-shut valve 300. More particularly, the slam-shut valve 1200 is oriented so that the valve plug 404, the piston 450, and the valve stem 500 of the pressure trim assembly 304 move in a direction that is opposite to the direction of movement when employed in the slam-shut valve 300. For example, in the slam-shut valve 1200, the downward movement of the piston 450 and the valve stem 500 causes the valve plug 404 to move into the closed position (as opposed to the open position, as is the case in the slam-shut valve 300). Orienting the slam-shut valve 1200 in this manner can, for example, help to prevent the accumulation of liquid in the plug cap 570, as the liquid is directed out of the plug cap 570 and into the fluid passageway 332 instead of freezing within the plug cap 570 and potentially interfering with the proper movement of the valve plug 404.

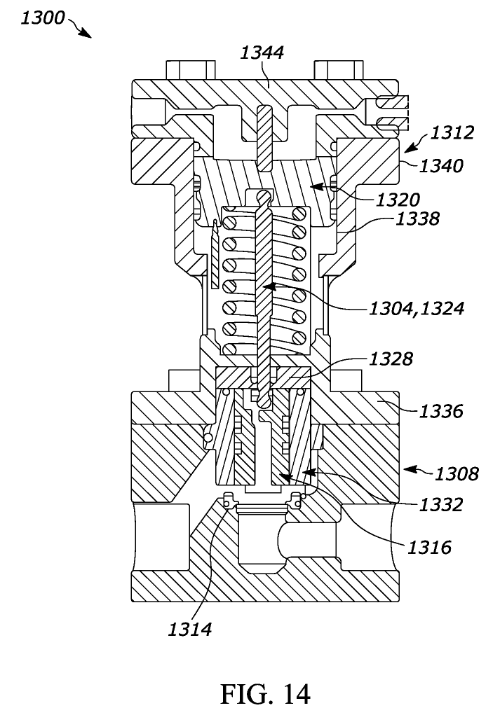

FIG. 14 illustrates another example of a valve 1300 that can employ a pressure trim assembly 1304 constructed in accordance with the teachings of the present disclosure. The valve 1300 is similar to the valve 300, in that the valve 1300 is also a slam-shut valve that includes a valve body 1308, an actuator 1312, and the pressure trim assembly 1304, which likewise includes a valve seat 1314, a valve plug 1316, a piston 1320, and a valve stem 1324 that are substantially similar to the valve seat 400, the valve plug 404, the piston 450, and the valve stem 500, respectively. However, the slam-shut valve 1300 is different in several respects. First, the pressure trim assembly 1304 does not include a guide plate (e.g., the guide plate 534). Instead, the pressure trim assembly 1304 includes a bonnet plate 1328 that is solely responsible for preventing radial movement of the valve stem 1324. Second, while the pressure trim assembly 1304 has a plug cap 1332 that receives and retains the valve plug 1316, just like the pressure trim assembly 304, the plug cap 1332 is captured between the valve body 1308 and a valve bonnet 1336 of the actuator 1312, such that in this example the plug cap 1320 engages the bonnet plate 1316. Third, while the pressure trim assembly 1304 also has a piston chamber 1338 for movably receiving the piston 1320, that piston chamber 1338 is solely defined by a central bore of a spring case 1340 of the actuator 1312. Fourth, while the slam-shut valve 1300 includes a flange 1344 like the flange 316, in this example the flange 1344 is coupled to the spring case 1340 and serves as the cover for the actuator 1312 and the piston chamber 1336. Fifth, in this example, the valve seat 1314 is located below the valve plug 1316 and the plug cap 1332. Thus, as in the slam-shut valve 1200, during operation of the slam-shut valve 1300, the downward movement of the piston 1320 and the valve stem 1324 causes the valve plug 1316 to move into the closed position (as opposed to the open position, as is the case in the slam-shut valve 300).

Finally, it will be appreciated many of the components of the valves described herein (e.g., the slam-shut valve 300) are generally made of one or more metal materials. Preferably, the valve plug 404, the piston 450, and the valve stem 500 are made of one or more materials resistant to hydrogen corrosion. Further, it is preferable that any components of the valves described herein (e.g., the slam-shut valve 300) that are not made of any metallic materials also be made of one or more non-metallic materials that are not dissolvable by hydrogen.

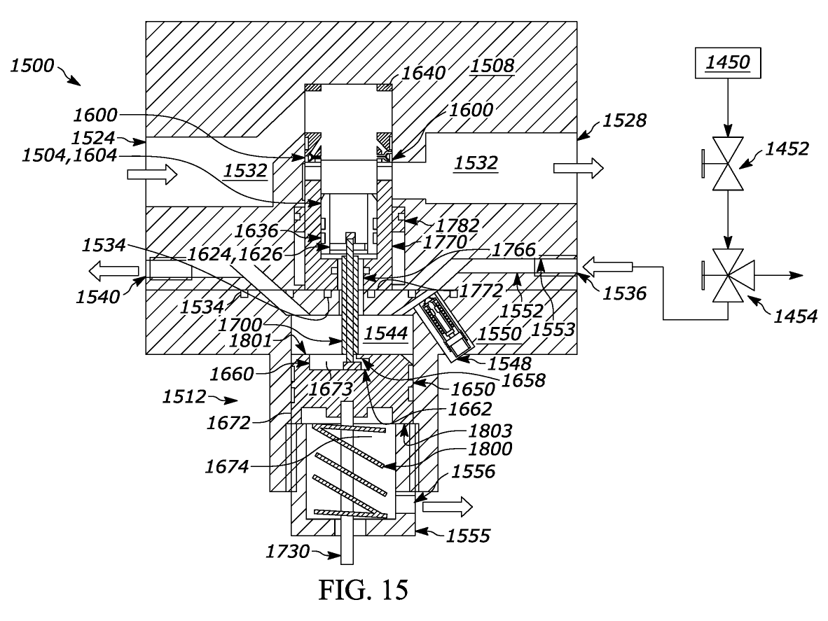

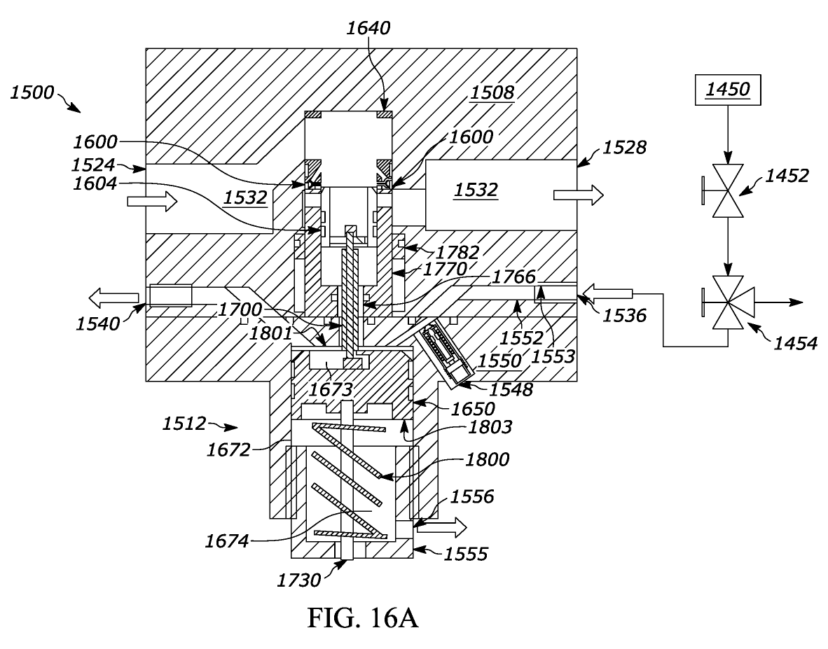

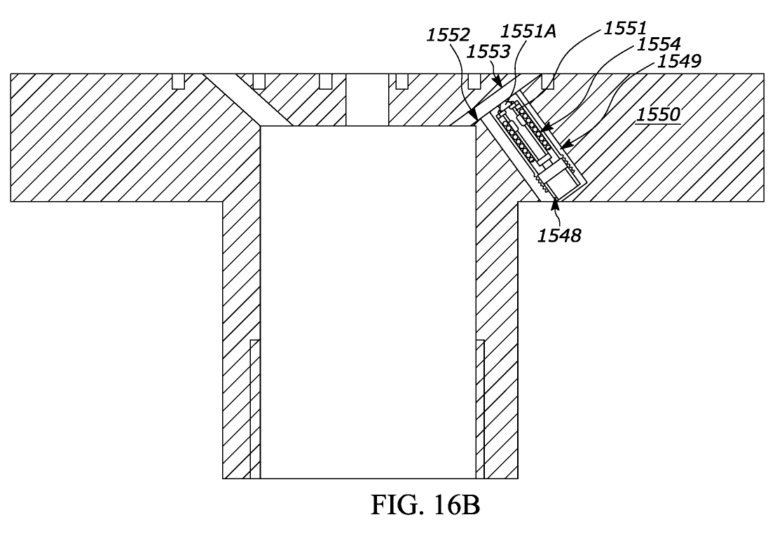

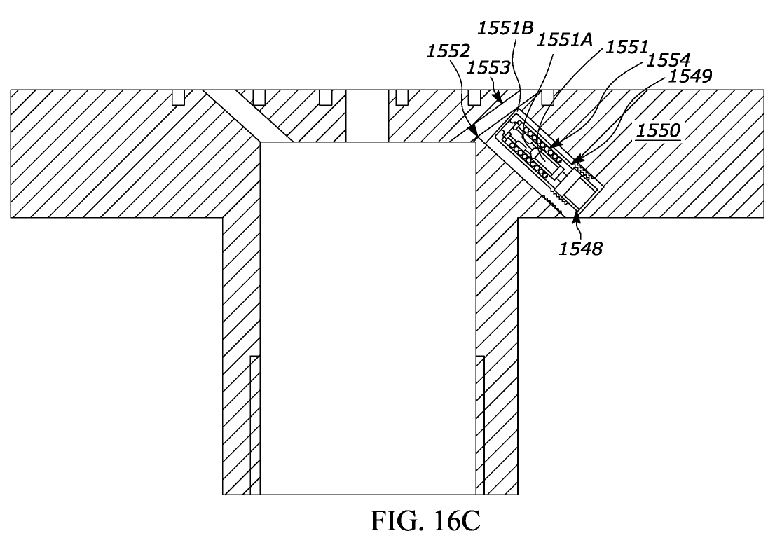

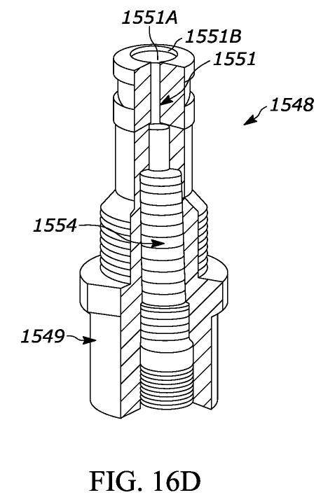

FIGS. 15-16C illustrate another example of a valve 1500 constructed in accordance with the teachings of the present disclosure. The valve 1500 is similar to the valve 300, in that the valve 1500 is also a slam-shut valve that includes a pressure trim assembly 1504, a valve body 1508, an actuator 1512, a fluid inlet 1524, a fluid outlet 1528, and a fluid passageway 1532 that are substantially similar to the pressure trim assembly 304, the valve body 308, the actuator 312, the fluid inlet 324, the fluid outlet 328, and the fluid passageway 332, respectively. However, the valve 1500 differs in several respects.

First, while the actuator 1512 includes a valve bonnet 1550 and a spring case 1555 including a vent opening 1556, like the actuator 312, the valve bonnet 1550 includes one or more grooves 1534 configured to receive one or more sealing elements (e.g., O-rings, not shown) to seal against the valve body 1508 when the valve body 1508 is coupled to the actuator 1512 (and vice-versa).

Second, while the pressure trim assembly 1504 includes a main valve stem 1700 that is substantially similar to the main valve stem 500 and the valve 1500 includes a plug cap 1770 (which can also be referred to as a cage) that includes a guide bore 1766 and a flange 1782 that are substantially similar to the guide bore 566 and the flange 582, respectively, the flange 1782 is disposed in a different location relative to the plug cap 1770 (as compared to the flange 582 relative to the plug cap 570). Specifically, the flange 1782 is disposed closer to an end of the plug cap 1770, adjacent to the fluid passageway 1532. Moreover, the pressure trim assembly 1504 does not include a separate guide plate 534, and instead the guide bore 1766 for the main valve stem 1700 is integrally formed in an end 1772 of the plug cap 1770 (see FIG. 15).

Third, the pressure trim assembly 1504 includes a valve seat 1600 and a valve plug 1604 that are similar to the valve seat 400 and the valve plug 404, respectively. The valve plug 1604 is likewise movable between an open position, in which the valve plug 1604 is spaced apart from the valve seat 1600, and a closed position, in which the valve plug 1604 is in contact with the valve seat 1600. Moreover, the valve plug 1604 includes a ledge 1624, a plug aperture 1626, and a second end 1636 that are substantially similar to the ledge 424, plug aperture 426, and second end 436, respectively. However, the valve plug 1604 differs from the valve plug 404 in that the valve plug 1604 is oriented differently than the valve plug 404. More particularly, the ledge 1624 and the plug aperture 1626 are disposed adjacent to the second end 1636, whereas the ledge 424 and the plug aperture 426 are disposed adjacent to the first end 432. In turn, the main valve stem 1700 is coupled to the valve plug 1604 at the second end 1636, whereas the main valve stem 500 is coupled to the valve plug 404 at the first end 432. The pressure trim assembly 1504 also includes an inlet sleeve 1640 that is disposed within the valve body 1508 to help retain the valve seat 1600 and the plug cap 1770 in position. As illustrated in FIGS. 15 and 16A, the inlet sleeve 1640 is disposed in the fluid passageway 1532 but at a position closer to the fluid inlet 1524 than the fluid outlet 1528. In this example, the inlet sleeve 1640 also helps to retain in position a sealing element 1648 (which in this example is a pressure activated sealing element) captured between the inlet sleeve 1640 and the plug cap 1770. The valve plug 1604 likewise includes a sealing element (not shown) that is positioned to sealingly engage the sealing element 1648 when the valve plug 1604 is in the closed position.

Fourth, the pressure trim assembly 1504 includes a piston 1650 that is similar to the piston 450. More particularly, the piston 1650 is movably disposed within a piston chamber 1672 that is similar to the piston chamber 372. The piston 1650 divides the piston chamber 1672 into a first portion 1673 and a second portion 1674. The first portion 1673 is defined between the valve bonnet 1550 and a top side 1801 of the piston 1650, whereas the second portion 1674 is defined between the spring case 1555 and a bottom side 1803 of the piston 1650. Moreover, the piston 1650 includes a piston ledge 1658, a piston aperture 1660, a piston groove 1662, and an actuator stem 1730 that are substantially similar to the piston ledge 458, the piston aperture 460, the piston groove 462, and the actuator stem 530, respectively. The piston 1650 differs from the piston 450 in that the piston 1650 is oriented differently than the piston 450. More particularly, the piston ledge 1658, the piston aperture 1660, and the piston groove 1662 are disposed adjacent to a second end 470 of the piston 1650 and the actuator stem 1730 is coupled to the second end 470.

Fifth, the valve 1500 includes different pressure ports than the valve 300. In particular, the valve 1500 includes an actuator inlet 1536, an actuator outlet 1540, and an actuator fluid passageway 1544 extending between and in fluid communication with the actuator inlet 1536 and the actuator outlet 1544. As can be best seen in FIGS. 15 and 16A, the actuator inlet 1536 and actuator outlet 1540 are disposed in the valve body 1508, and the actuator fluid passageway 1544 is disposed in the valve body 1508 and the valve bonnet 1550. The actuator fluid passageway 1544 is defined by a lower wall 1552 and an upper wall 1553 opposite the lower wall 1552. It will also be appreciated that the actuator fluid passageway 1544 includes the first portion 1673 of the piston chamber 1672. Beneficially, because the actuator inlet 1536 and the actuator outlet 1540 are disposed in the valve body 1508, as opposed to any part of the actuator 1512, the actuator 1512 is freed for removal from the valve body 1504. At the same time, the pressure trim assembly 1504 need not be disassembled in order to access the valve seat 1600, the valve plug 1604, the inlet sleeve 1640, and the plug cap 1770, each of which is disposed in the valve body 1508.

Sixth, the valve 1500 includes a spring 1800 that differs from the spring 600 in that the spring 1800 is configured to bias the valve plug 1604 into its closed position (as compared to the spring 600, which is configured to bias the valve plug 404 into its open position). To this end, the spring 1800 is disposed in the second portion 1674 of the piston chamber 1672 and biases the bottom side 1803 of the piston 1650 (and not the top side 1801 of the piston 1650). In turn, the spring 1800 applies a biasing force on the bottom side 1803 of the piston 1650.

The valves described herein can also include a relief valve configured to help reduce excess pressure therein. For example, as best seen in FIGS. 16B-16D, the valve 1500 can include a relief valve 1548 removably coupled to the valve bonnet 1550 and configured to limit the flow of fluid through the actuator fluid passageway 1544 when desired. The relief valve 1548 generally includes a body 1549, an arm 1551, a relief plug 1551A carried by an end of the arm 1551, and a relief spring 1554. The body 1549 is at least partially disposed in an aperture formed in the valve bonnet 1550. In this example, the relief valve 1548 is threaded to the valve bonnet 1550 via threads on the body 1549 that engage threads in the aperture formed in the valve bonnet 1550. The arm 1551 is disposed within the body 1549, and the relief spring 1554 is coupled to the arm 1551 and configured to bias the arm 1551 (particularly the relief plug 1551A) away from the body 1549 and into sealing engagement with a relief seat 1551B disposed at the end of the body 1549. When the relief valve 1548 is coupled to the valve bonnet 1550, the relief valve 1548 is movable between a first position, shown in FIG. 16B, and a second position, shown in FIG. 16C, responsive to a signal (e.g., an instruction from a central controller, a pressure signal) indicative of the pressure within the actuator fluid passageway 1554 being too high. In particular, when the relief valve 1548 in the first position, the relief plug 1551A sealingly engages the relief seat 1551B, such that the relief valve 1548 is closed and fluid flow through the actuator fluid passageway 1544 is unchanged. When the pressure within the actuator fluid passageway 1554 is too high, that pressure will overcome the biasing force applied by the relief spring 1554 and drive the relief plug 1551A away from the relief seat 1551B, opening the relief valve 1548. In the second position, the relief plug 1551A carried by the arm 1551 is spaced from the relief seat 1551B, which allows fluid flowing through the actuator fluid passageway 1544 to flow through and out of the relief valve 1548 via the body 1549, which in turn helps to relieve the excessive pressure within the actuator fluid passageway 1544.

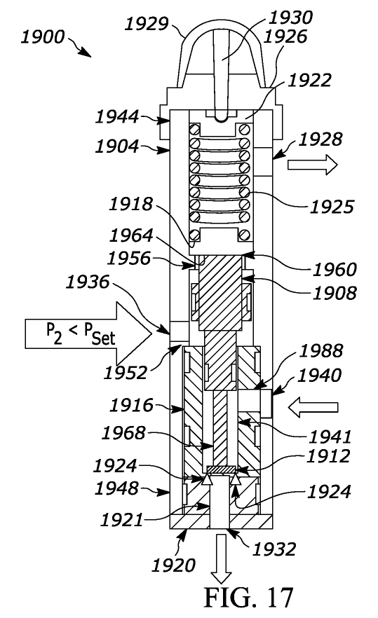

FIGS. 17-19 illustrate another example of a controller 1900 (which may instead be referred to as a pilot device, depending upon the given application) that is constructed in accordance with the teachings of the present disclosure and is for use with a valve such as one of the valves described herein (e.g., the valve 1500). The controller 1900 of this example includes a controller body 1904, a controller stem 1908, a control element 1912 coupled to the controller stem 1908, a controller sleeve 1916 disposed within the controller body 1904, a first spring seat 1918, a controller plug 1920, a second spring seat 1922, and a controller seat 1924. The controller 1900 also includes a control spring 1925, a base 1926, a cover 1929, and an adjusting screw 1930.

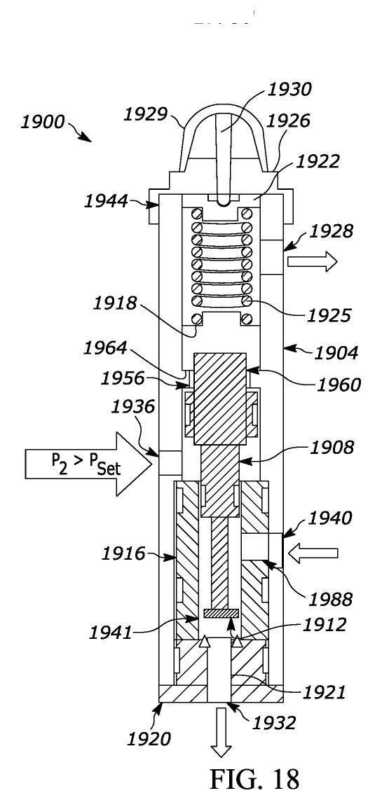

The controller body 1904 generally includes a first port 1936 and a second port 1940. The first port 1936, which may also be referred to herein as the pressure sensing port, is adapted to be in fluid communication with a pressure downstream of the valve. The second port 1940, which may also be referred to herein as the controller inlet, is adapted to be in fluid communication with an actuator outlet of the valve (e.g., the actuator outlet 1540). The controller body 1904 also includes a first vent opening 1928 and a second vent opening 1932. The first and second vent openings 1928, 1932 are generally in fluid communication with the atmosphere surrounding the controller 1900. The controller sleeve 1916 is at least partially disposed in the controller body 1904, and the controller seat 1924 is at least partially disposed within the controller body 1904. The control element 1912 is movably disposed within the controller body 1904 relative to the controller seat 1924 between a first position (shown in FIG. 17) and a second position (shown in FIG. 18) responsive to a downstream overpressure condition detected via the first port. In the present example, when the control element 1912 is in the first position, the controller 1900 is in a closed position, and when the control element 1912 is in the second position, the controller 1900 is in an open position that causes the valve to which the controller 1900 is connected to close via the second port 1940. Further details regarding the overpressure condition will be discussed below.

The controller body 1904 is intended to house the components of the controller 1900. In the present example, the controller body 1904 has a substantially or entirely cylindrical shape defined by a first end 1944 adjacent to the first vent opening 1928, a second end 1948 opposite the first end 1944, and a substantially cylindrical wall extending between the first end 1944 and second end 1948. In the present example, the substantially cylindrical wall includes the first vent opening 1928, the first port 1936, and the second port 1940. However, one of skill in the art would appreciate that the controller body 1904 can have a different shape including, for example, a square, triangle, rectangle, oval, or other suitable shape. Moreover, one of skill in the art would appreciate that the controller body 1904 may have a different length than in the present example to accommodate, for example, the controller stem 1908, the controller sleeve 1916, and the controller plug 1920. Furthermore, it will be appreciated that the controller body 1904 may be formed of one or more rigid or semi-rigid materials, including but not limited to any combination of metals, plastics, or other similar materials. Further yet, one of skill in the art will appreciate that the first vent opening 1928, the first port 1936, and the second port 1940 may be disposed at any point along the controller body 1904 to accommodate, for example, the location of the controller stem 1908, the controller sleeve 1916, and the controller plug 1920. Finally, one of skill in the art will appreciate that the first vent opening 1928 can be sealed (e.g., with a plug removably inserted into the first vent opening 1928) or can be fluidly connected to another chamber (e.g., of another pressure regulating device).

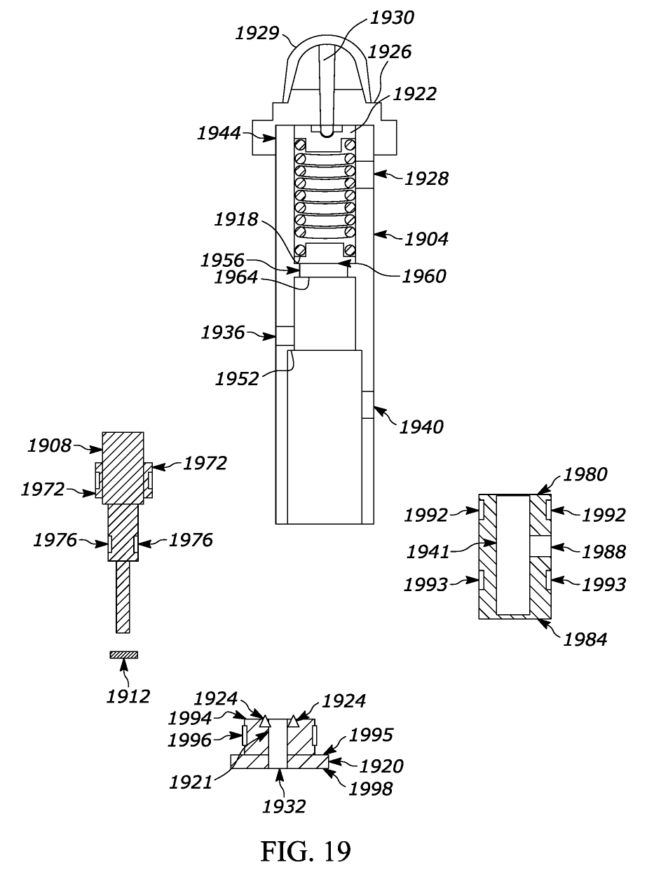

As best illustrated by FIG. 19, the controller body 1904 further includes a first ledge 1952, a second ledge 1956, and an aperture 1960. The first ledge 1952, which may also be referred to herein as the sleeve ledge, is intended to stop further travel of the controller sleeve 1916 in the direction of the first end 1944. In the present example, the first ledge 1952 is disposed between the first port 1936 and the second port 1940; however, one of skill in the art will appreciate that the first ledge 1952 may be disposed at any point along the controller body 1904 to accommodate, for example, the controller sleeve 1916, the controller plug 1920, the first port 1936, and the second port 1940. The second ledge 1956 is intended to stop further travel of the controller stem 1908 in the direction of the first end 1944. In the present example, the second ledge 1956 is disposed between the first port 1936 and the first vent opening 1928, such that the second ledge 1956 is disposed closer to the first end 1944 than the first ledge 1952; however, one of skill in the art will appreciate that the second ledge 1956 may be disposed at a different location along the controller body 1904 to accommodate, for example, the controller stem 1908, the first port 1936, and the first vent opening 1928. The second ledge 1956 further defines the aperture 1960 that is sized to accommodate a first end 1964 of the controller stem 1908 intended to be movably disposed within the controller body 1904. One of skill in the art will appreciate that the aperture 1960 may be of any suitable size or shape to accommodate the size and shape of the controller stem 1908. Moreover, in the present example and as illustrated in FIG. 17, the first end 1964 of the controller stem 1908 is substantially in-line with a top edge of the second ledge 1956 when the controller 1900 is in its closed position. And, as illustrated in FIG. 18, the first end 1964 of the controller stem 1908 is spaced apart from the top edge of the second ledge 1956 when the controller 1900 is in its open position.

The controller stem 1908 is intended to relate the overpressure condition detected via the first port with the open position and the closed position for the controller 1900 by moving the control element 1912 between its first and second positions. The controller stem 1908 is at least partially disposed in the controller body 1904. In the present example, the controller stem 1908 is entirely disposed in the controller body 1904. Furthermore, the controller stem 1908 in the present example is engaged with and at least partially disposed in the controller sleeve 1916. In the present example, the controller stem 1908 is substantially cylindrical and is defined by the first end 1964 and a second end 1968 that is opposite the first end 1964 and has a smaller cross-sectional area than the first end 1964. However, one of skill in the art will appreciate that the controller stem 1908 can have a different shape including, for example, a square, triangle, rectangle, oval, or other suitable shape. Additionally, although in the present example the second end 1968 of the controller stem 1908 has a cross-sectional area less than the first end 1964, one of skill in the art will appreciate that the second end 1968 may have a cross-sectional area equal to or greater than the first end 1964 to accommodate, for example, the controller body 1904 and the controller sleeve 1916.

The controller stem 1908 further includes a first sealing element 1972 and a second sealing element 1976. The first sealing element 1972 is arranged in an outer surface of the controller stem 1908 such that the first sealing element 1972 is circumferentially around the controller stem 1908. In the present example, the first sealing element 1972 is an annular gasket that is disposed adjacent to the first end 1964 of the controller stem 1908. However, one of skill in the art will appreciate that the first sealing element 1972 may be disposed at a different location along the controller stem 1908 to accommodate, for example, the second ledge 1956 and aperture 1960. The first sealing element 1972 is arranged to sealingly engage an inner surface of the controller body 1904, such that the first sealing element 1972 fluidly isolates the first port 1936 from the first vent opening 1928. Additionally, one of skill in the art will appreciate that the first sealing element 1972 may be a different type of seal, for example, an O-ring seal.

The second sealing element 1976 is also arranged in the outer surface of the controller stem 1908 such that the second sealing element 1976 is also circumferentially around the controller stem 1908. However, the second sealing element 1976 is disposed in a different location along the controller stem 1908. In the present example, the second sealing element 1976 is disposed between the first sealing element 1972 and the second end 1968 of the controller stem 1908. However, one of skill in the art will appreciate that the second sealing element 1976 may be disposed at aa different location along the controller stem 1908 to accommodate, for example, the controller sleeve 1916 and the second port 1940. The second sealing element 1976 is arranged to sealingly engage the controller sleeve 1916, such that the second sealing element 1976 fluidly isolates the first port 1936 from the second port 1940 and the first vent opening 1928. Additionally, one of skill in the art will appreciate that the second sealing element 1976 may be a different type of seal, for example, an O-ring seal.

As best illustrated by FIGS. 17 and 18, the first spring seat 1918 is coupled to the end 1964 of the controller stem 1908 such that the first spring seat 1918 is disposed within the controller body 1904. The second spring seat 1922 is also disposed within the controller body 1904 but at a position at or immediately adjacent the first end 1944 of the controller body 1904. The control spring 1925 has one end seated against the first spring seat 1918 and another end seated against the second spring seat 1922. So positioned, the control spring 1925 is configured to apply a biasing force on the first spring seat 1918 so as to bias the first spring seat 1918 into contact with the first end 1964 of the controller stem 1908. In other words, the first end 1964 of the controller stem 1908 is loaded by the control spring 1925 via the first spring seat 1918. This, in turn, biases the control element 1912 towards its first, closed position. The base 1926, meanwhile, is coupled to the controller body 1904 such that the base 1926 covers or encloses the first end 1944 of the controller body 1904. The adjusting screw 1930 is disposed in and extends through a bore formed in the base 1926, with one end seated against the second spring seat 1922 and another end disposed outside of the controller 1900. The cover 1929 selectively covers the adjusting screw 1930 to prevent access to the adjusting screw 1930. However, when the cover 1929 is removed, the adjusting screw 1930 can be adjusted to decrease or increase the biasing force generated by the control spring 1925. In any event, it will be appreciated that the biasing force at least partially defines the pre-determined pressure set-point of the controller 1900, such that adjustment of the biasing force generated by the control spring 1925 also adjusts the pre-determined pressure set-point of the controller 1900.

As best illustrated by FIGS. 17 and 18, the control element 1912 is coupled to the second end 1968 of the controller stem 1908 and is intended to engage the controller seat 1924 when the control element 1912 is in its second position (and, thus, the controller 1900 is in its closed position). In the present example, the control element 1912 is a conical disc; however, one of skill in the art will appreciate that the control element may be a plug and/or can have a different shape including, for example, a square, oval, or rectangle to accommodate, for example, the controller stem 1908, the controller sleeve 1916, or the controller seat 1924. Moreover, in the present example, the control element is coupled to the controller stem 1908 via a threaded connection. However, one of skill in the art will appreciate that the control element 1912 may be coupled to the controller stem 1908 through any suitable means that provides the requisite connection strength, including, but not limited to, a press fit, snap fit, or adhesive.

The controller sleeve 1916 is at least partially disposed in the controller body 1904 and is configured to separate the first port 1936 from the second port 1940 (and vice versa). In the present example, the controller sleeve 1916 is entirely disposed in the controller body 1904. As best illustrated in FIG. 19, in this example the controller sleeve 1916 has a substantially cylindrical shape defined by a first end 1980 adjacent to the pressure sensing opening 1936, a second end 1984 opposite the first end 1980, and a substantially circular wall extending between the first end 1980 and second end 1984. The first end 1980 of the controller sleeve 1916 is disposed against the ledge 1952 in the controller body 1904, whereas the second end 1984 of the controller sleeve 1916 engages the controller plug 1920. The controller sleeve 1916 also includes a sleeve inlet port 1988. The sleeve inlet port 1988 is aligned coaxially and in fluid communication with the second port 1940 and a sleeve fluid passageway 1941, such that the sleeve inlet port 1988 fluidly connects the second port 1940 with the sleeve fluid passageway 1941 (and vice-versa). While in this example the controller sleeve 1916 has a substantially cylindrical shape, one of skill in the art would appreciate that the controller sleeve 1916 can have a different shape including, for example, a square, triangle, rectangle, oval, or other suitable shape. Moreover, one of skill in the art would appreciate that the controller sleeve 1916 may have a different length than the sleeve 1916 in the present example to accommodate, for example, the controller body 1904, the controller stem 1916, second port 1940, and/or the sleeve inlet port 1988 having different shapes and/or sizes.

The controller sleeve 1916 further includes a first sealing element 1992 and a second sealing element 1993. The first sealing element 1992 is arranged circumferentially around the controller sleeve 1916 and is configured to sealingly engage the controller body 1904 such that the first sealing element 1992 is intended to prevent fluid from flowing between the controller body 1904 and the controller sleeve 1916. In the present example, the first sealing element 1992 is disposed between the second ledge 1956 and the sleeve inlet port 1988 and forms a groove seal. However, one of skill in the art will appreciate that the first sealing element 1992 may be disposed at any point along the controller sleeve 1916 to accommodate, for example, the controller stem 1908 and the second port 1940. Additionally, one of skill in the art will appreciate that the first sealing element 1992 may form a seal with the controller body 1904 in any other suitable way including, for example, an O-ring seal or a compression gasket. The second sealing element 1993 is substantially similar to the first sealing element 1992 and differs only in that the second sealing element 1993 is disposed between the sleeve inlet port 1988 and the second end 1984 and is configured to prevent fluid from flowing between the controller body 1904 and the controller sleeve 1916 so as to fluidly isolate the second port 1940 from the second vent opening 1932. However, one of skill in the art will appreciate that the second sealing element 1993 may be disposed at any point along the controller sleeve 1916 to accommodate, for example, the controller stem 1908 and the second port 1940.

The controller plug 1920 is generally configured to retain the other components of the controller 1900 (e.g., the controller sleeve 1916) within the controller body 1904. In the present example, the controller plug 1920 is at least partially disposed in the controller body 1904. As best illustrated in FIG. 19, the controller plug 1920 in the present example has a substantially cylindrical shape defined by a first end 1994 a second end 1998 opposite the first end 1994, a substantially circular wall extending between the first end 1994 and second end 1998, and a flanged portion 1995 configured to engage with the second end 1948 of the controller body 1904. The first end 1994 is engaged with the controller sleeve 1916 within the controller body 1904, whereas the second end 1998 is disposed outside of the controller body 1904 and serves to cap the second end 1948 of the controller body 1904. And, as best illustrated by FIGS. 17 and 18, the flange 1995 in the present example conforms to the thickness of the controller body 1904. However, one of skill in the art will appreciate that the size of the flange 1995 may differ to accommodate a differently sized controller body 1904 or the flange 1995 may have a thickness that is different from the thickness of the controller body 1904. The controller plug 1920 also includes a plug fluid passageway 1921 that extends between the first end 1994 and the second end 1998. However, one of skill in the art would appreciate that the controller plug can have a different shape including, for example, a square, triangle, rectangle, oval, or other suitable shape. Moreover, one of skill in the art would appreciate that the controller plug 1920 may have a different length than in the present example to accommodate, for example, the controller body 1904 and the controller sleeve 1916 having different shapes and/or sizes.

The controller plug 1920 further includes the second vent opening 1932 and a first sealing element 1996. The second vent opening 1932 is disposed at the second end 1998 of the controller plug 1920 and is in fluid communication with the plug fluid passageway 1921. The first sealing element 1996 is arranged circumferentially around the controller plug 1920 and is configured to sealingly engage the controller body 1904 such that the first sealing element 1996 prevents fluid from flowing between the plug body 1904 and the controller plug 1920. In the present example, the first sealing element 1996 is disposed between the first end 1994 and the second end 1998 and forms a groove seal. However, one of skill in the art will appreciate that the first sealing element 1996 may be disposed at any point along the controller plug 1920 to accommodate, for example, the controller body 1904 and the controller sleeve 1916. Additionally, one of skill in the art will appreciate that the first sealing element 1996 may form a seal with the controller body 1904 in any other suitable way including, for example, an O-ring seal or a compression gasket.

In the present example, the controller seat 1924 is carried by the controller plug 1920. More particularly, in the present example, the controller seat 1924 is integrally formed with the controller plug 1920 at the first end 1994. In the present example, the controller seat 1924 is substantially shaped as a triangular prism in cross-section, and extends into the sleeve fluid passageway 1941. However, one of skill in the art would appreciate that the controller plug can have a different cross-sectional shape including, for example, a square, circle, rectangle, oval, or other suitable shape. As seen in FIG. 17, when the control element 1912 is in its first position, the controller seat 1924 engages the control element 1912, thereby preventing the first pressure from being in fluid communication with the second vent opening 1932 and closing the controller 1900.

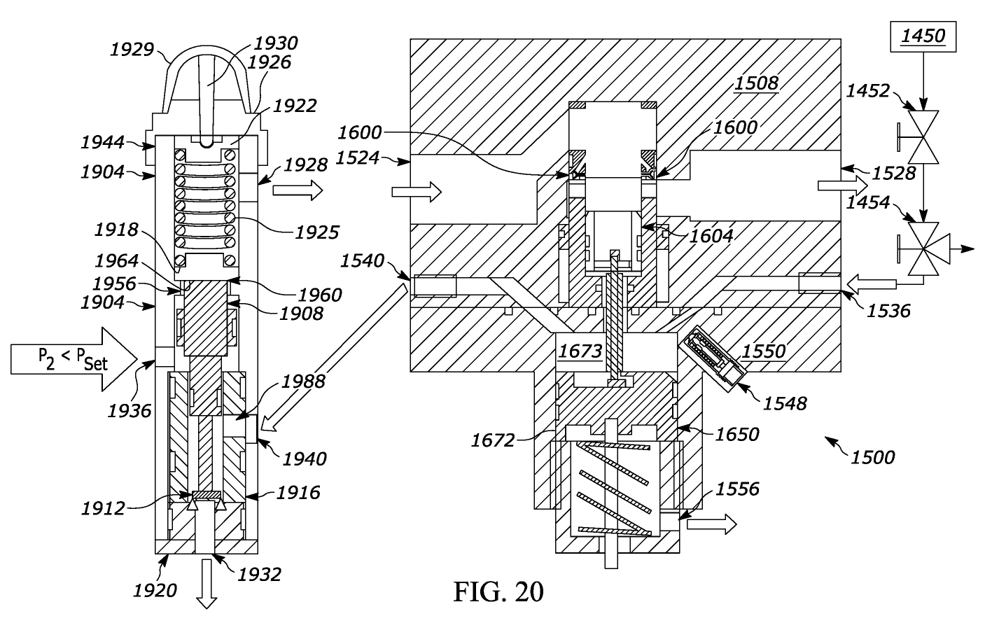

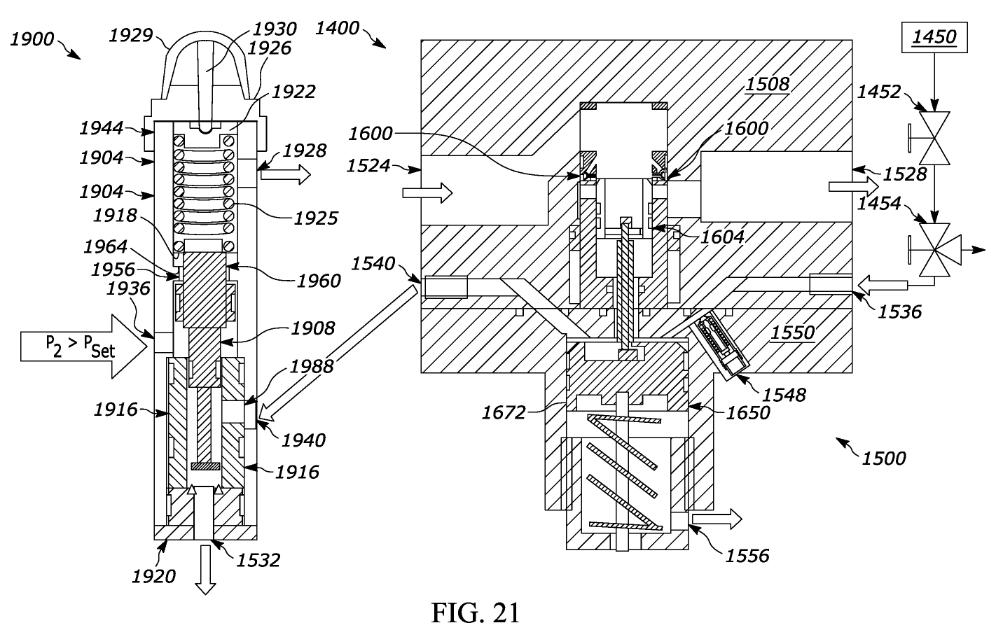

FIGS. 20 and 21 illustrate one example of a valve assembly 1400 that includes the controller 1900 operatively coupled to the valve 1500 to control the valve 1500 responsive to detection of an overpressure condition (i.e., a pressure that exceeds the pre-determined pressure set-point of the controller 1900) downstream of the valve 1500 via the first port 1936. In particular, the first port 1936 of the controller 1900 is fluidly coupled to a downstream pressure (which is generally equivalent to the pressure of the fluid leaving the fluid outlet 1528), and the actuator outlet 1540 of the valve 1500 is in fluid communication with the second port 1940 of the controller 1900.

The valve assembly 1400 also includes a fill actuator 1450 configured to selectively supply actuator fluid to the valve 1500 to actuate the valve 1500 (and, more particularly, the actuator 1512 and the pressure trim assembly 1504). As best seen in FIGS. 15 and 16A, the fill actuator 1450 is in fluid communication with the actuator inlet 1536. In this example, the fill actuator 1450 is a pneumatic actuator configured to provide a pre-determined amount of actuator fluid (e.g., air) to the valve 1500 to selectively actuate the valve 1500. In the present example, the fill actuator 1450 is coupled to the actuator inlet 1536 via a conventional shut-off valve 1452 (e.g., a ball valve) a conventional three-way valve 1454 connected to and located downstream of the shut-off 1452, such that the fill actuator 1450 has four modes, a filling mode, an operating mode, a tripped mode, and an idle or unengaged mode. In the filling mode, the shut-off valve 1452 is open and the three-way valve 1454 is positioned to fluidly connect the shut-off valve 1452 (and the actuator 1450 connected thereto) to the actuator inlet 1536, such that the fill actuator 1450 is configured to move the valve assembly 1400 from a first state to a second state (further described below) by providing the pre-determined amount of fluid to the valve 1500 (i.e., by filling the piston chamber 1672). In the operating mode, the fill actuator 1450 remains ready to fill the valve assembly 1400 as needed. In the tripped mode, which is typically triggered responsive to detection of the overpressure condition, the actuator fluid provided by the fill actuator 1450 is vented by the three-way valve 1454 such that no actuator fluid is used to fill the valve assembly 1400. Finally, in the idle or unengaged mode, the shut-off valve 1452 is closed, such that no actuator fluid is provided by the actuator 1450, and the valve assembly 1400 is shut down. In other examples, however, it will be appreciated that the fill actuator 1450 can be coupled to the actuator inlet 1536 via one valve (e.g., the shut-off valve 1452 or the three-way valve 1454) or more than two valves.

In FIG. 20, the valve assembly 1400 is in the first or normal operational state in which the valve 1500 is in its open position and the controller 1900 is in its closed position. When the valve assembly 1400 is in the first state, the valve plug 1604 is spaced apart from the valve seat 1600 and the control element 1912 is engaged with the controller seat 1924, respectively. Thus, process fluid flows through the fluid inlet 1524, the fluid passageway 1532, and the fluid outlet 1528 of the valve 1500. Moreover, in the first state, the actuator fluid in the actuator fluid passageway 1544 (and, more specifically, the first portion 1673 of the piston chamber 1672) provided by the fill actuator 1450 has an actuator pressure that generates a force against the piston 1650 (specifically the top side 1801) that exceeds the biasing force generated by the biasing spring 1800 and acting on the bottom side 1803 of the piston 1650, thereby keeping the valve 1500 in its open position. Additionally, the actuator fluid outlet 1540 is in fluid communication with the second port 1940, the sleeve inlet port 1988, and the sleeve fluid passageway 1941, such that the sleeve fluid passageway 1941 includes actuator fluid having the actuator pressure.

When the valve assembly 1400 is in the first state, the actuator pressure in the sleeve fluid passageway 1941 generates a force (downward in the present example) that acts on the control element 1912 and that force, together with the biasing force generated by the control spring 1925, is sufficient to maintain the control element 1912 in engagement with the controller seat 1916. More particularly, the pressure of the fluid entering or otherwise in fluid communication with the first port 1936 of the controller 1900 generates an (upward) force on the controller stem 1908 that is less than the (downward) biasing force generated by the control spring 1925 and the (downward) force generated by the actuator pressure in the sleeve fluid passageway 1941. The valve assembly 1400 continues to operate in the first state subject to detection of the downstream overpressure condition. That is, in the present example, so long as the pressure of the fluid entering or otherwise in fluid communication with the first port 1936 of the controller 1900 remains below the pre-determined pressure set point of the controller 1900, the controller 1900 and the valve 1500 will remain in their closed and open positions, respectively. One of skill in the art will appreciate that the pre-determined set-point is dependent on a variety of factors including, for example, the biasing force generated by the control spring 1925, the cross-sectional area, volume, and density of the controller stem 1908, the shape and size of the control element 1912, and the pressure of the actuator fluid in the sleeve fluid passageway 1941. In other words, the set-point and the corresponding relevant factors define a set pressure above which the controller 1900 and the valve assembly 1400 transition from the first state to a second state.

When the downstream pressure detected by the first port 1936 increases and exceeds the pre-determined pressure set point (i.e., reaches the overpressure condition), the pressure increase causes the force generated by the downstream pressure detected by the first port 1936 to overcome the biasing force generated by the control spring 1925, which thereby causes the controller stem 1908 to move in a direction (upward in the present example) towards the first end 1944 of the controller body 1904 until the controller stem 1908 engages the ledge 1956. This movement causes the control element 1912 to move in the same direction and out of engagement with and away from the controller seat 1916. In turn, the sleeve fluid passageway 1941 is fluidly coupled to the plug passageway 1921. The pressure within the sleeve fluid passageway 1941, previously capped from entering the second vent opening 1932 due to the control element 1912 being engaged with the controller seat 1924, flows out to the atmosphere through the second vent opening 1932. The actuator pressure trapped within the first portion 1673 of the piston chamber 1672) is released via the actuator outlet 1540 and also flows out to the atmosphere through the second vent opening 1932. At this point, the pressure trim assembly 1504 of the valve 1500 slams shut and the valve assembly 1400 moves from the first state to a second state, or shut-off state, in which the valve 1500 is in its closed position and the controller 1900 is in its open position.

As illustrated in FIG. 21, the second state of the valve assembly 1400 differs from the first state in the following ways. First, as previously mentioned, the control element 1912 is spaced apart from the controller seat 1924. Second, the valve plug 1804 is engaged with the valve seat 1600, and thus the fluid is prevented from flowing from the fluid inlet 1524 to the fluid outlet 1528. Third, the piston 1650 is engaged with the upper wall 1553 of the valve bonnet 1550 of the actuator 1512, thereby preventing fluid from flowing from the actuator inlet 1536 to the actuator outlet 1540.

The valve assembly 1400 will continue in the second state subject to the resolution of the overpressure condition and the fill actuator 1450 returning to the fill mode. Once the overpressure condition is resolved (and the downstream pressure no longer exceeds the pre-determined pressure set point), the controller 1900 returns to its closed position. In the fill mode, the fill actuator 1450 fills the actuator fluid passageway 1544 (via the actuator inlet 1536) to the pre-determined arming pressure that causes the piston 1650 to move away from the upper wall, thereby opening the valve 1500. Once the fill actuator 1450 has filled the valve 1500 to the pre-determined arming pressure, the fill actuator 1450 enters the operating mode and the valve assembly 1400 returns to the first state, as illustrated in FIG. 20.

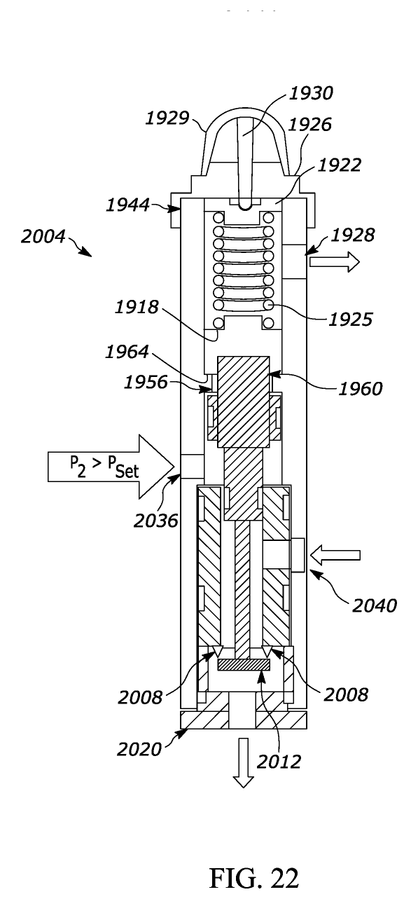

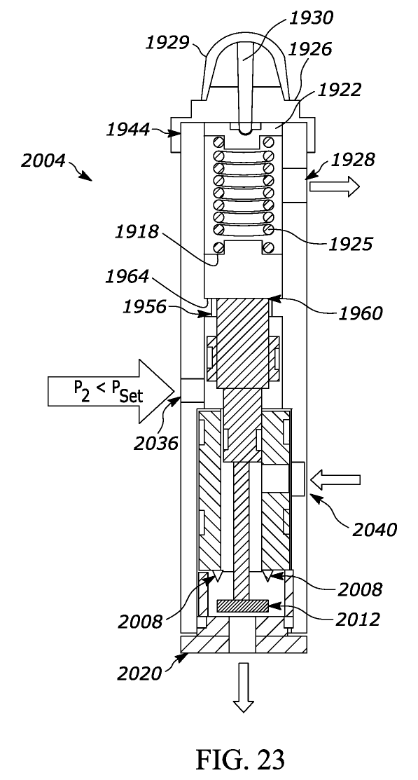

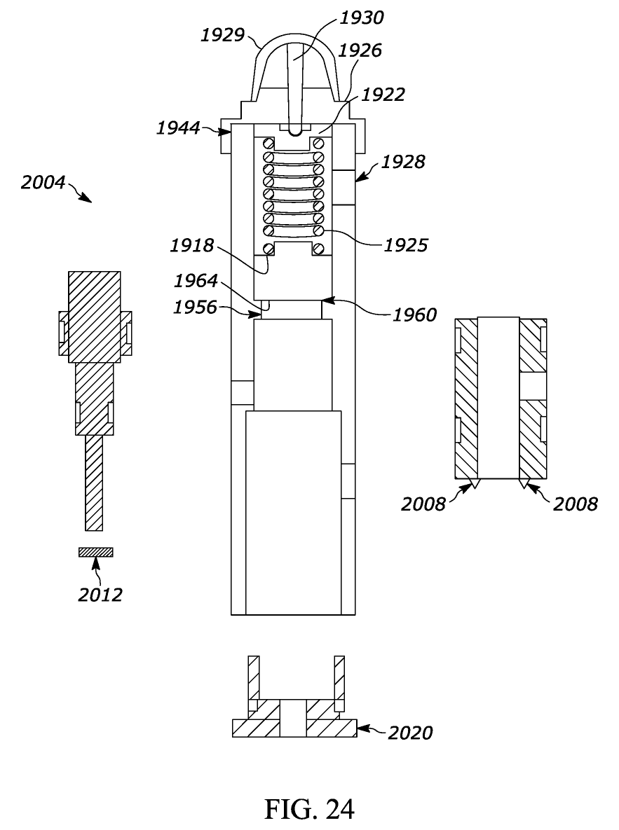

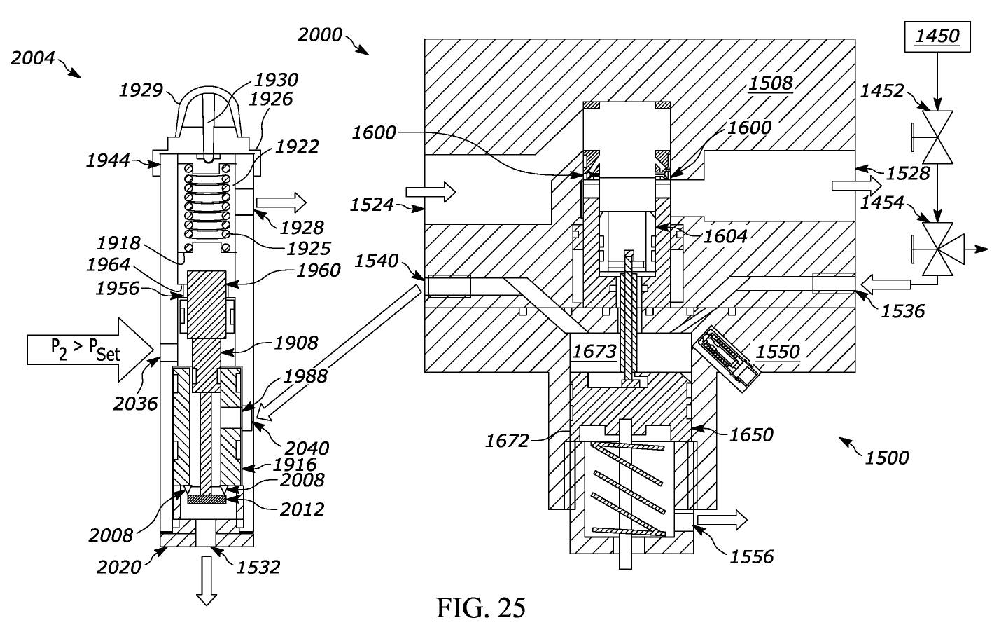

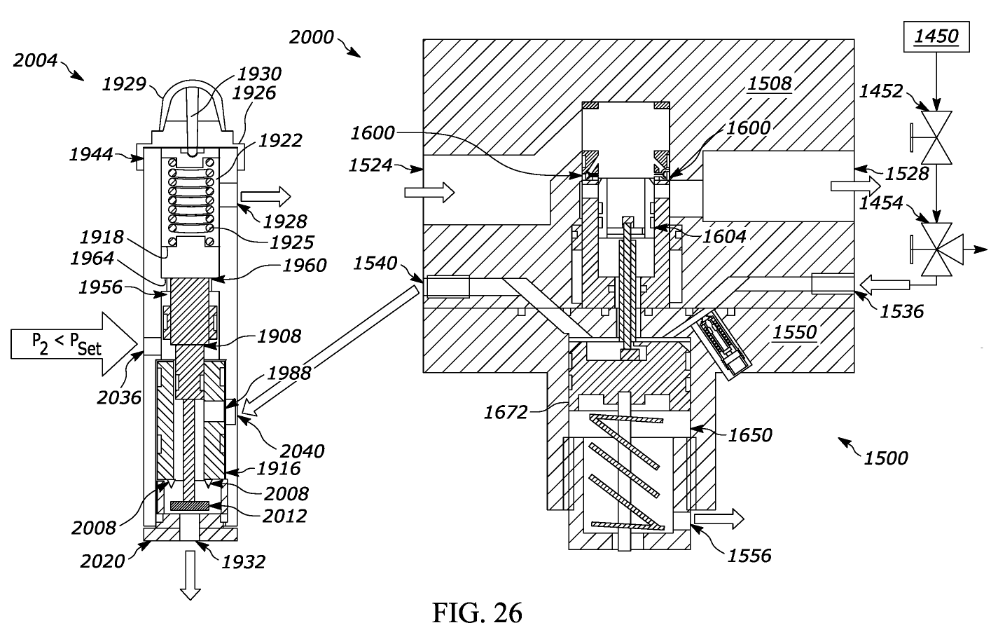

FIGS. 22-24 illustrate another example of a controller 2004 that is constructed in accordance with the teachings of the present disclosure, and FIGS. 25 and 26 illustrate another example of a valve assembly 2000 that is constructed in accordance with the teachings of the present disclosure and includes the valve 1500 coupled to and in fluid communication with the controller 2004. The controller 2004 is substantially similar to the controller 1900 but differs in several respects. First, the controller 2004 has a controller seat 2008 that differs from the controller seat 1924 in that the controller seat 2008 is carried by (e.g., integrally formed with) the second end 1984 of the controller sleeve 1916. Second, the controller 2004 has a control element 2012 that differs from the control element 1912 in that the control element 2012 is slightly larger to accommodate engagement with the controller seat 2008 when the controller 2004 is in its closed position, shown in FIG. 22. Third, the controller 2004 has a controller plug 2020 that differs from the controller plug 1920 in that the controller plug 2020 is shaped to accommodate the aforementioned changes to the location of the controller seat 2008 and the shape of the control element 2012. Fourth, the controller 2004 controls the valve 1500 responsive to detection of an underpressure condition (i.e., a pressure that is less than a pre-determined pressure set-point of the controller 2004) downstream of the valve 1500 via the first port 2036 of the controller 2004. Fifth, and finally, while the controller 2004 has a control spring 2025 that, like the control spring 1925, applies a biasing force on the first spring seat 1918 so as to bias the first spring seat 1918 into contact with the first end 1964 of the controller stem 1908, this biasing force biases the control element 2108 away from the controller seat 2112, towards its open position.

Notwithstanding these differences, the valve assembly 2000 operates in substantially the same manner as the valve assembly 1400, albeit in response to detection of an underpressure condition rather than an overpressure condition. Thus, like the valve assembly 1400, the valve assembly 2000 is movable between a first state (shown in FIG. 25) and a second state (shown in FIG. 26). When the valve assembly 2000 is in the first state, the valve 1500 and the controller 2004 are in their open and closed positions, respectively. With the valve 1500 in its open position, the piston 1650 is subject to the actuator pressure generated by the actuator fluid in the actuator fluid passageway 1544, and the actuator pressure is greater than the force applied by the spring 1800. Meanwhile, with the controller 2004 in its closed position, the control element 2012 of the controller 2004 is engaged with the controller seat 2008.

The valve assembly 2000 will continue in the first state subject to detection of the downstream underpressure condition. Upon detecting (via the first port 1936) that the downstream pressure decreases and is less than the pre-determined pressure set point, the valve assembly 2000 will move to the second state. That is, the pressure decrease allows the biasing force applied by the control spring 2025, which is now greater than the force generated by the downstream pressure at the first port 1936, to cause the controller stem 1908 of the controller 2004 to move in a direction (downward in the present example) towards the second end 1948 of the controller body 1904, which causes the control element 2012 to move in the same direction and out of engagement and away from the controller seat 2008, thereby opening the controller 2004. As illustrated by FIG. 26, when the control element 2012 is spaced apart from the controller seat 2008, the actuator fluid passageway 1544, the actuator fluid outlet 1536, the second port 2040, the sleeve inlet port 1988, the sleeve fluid passageway 1941, and the plug fluid passageway 1921 are in fluid communication with the atmosphere through the second vent opening 1932, which causes the actuator pressure trapped within the first portion 1673 of the piston chamber 1672 to be released by flowing out to the atmosphere through the second vent opening 1932, thereby closing the valve 1500. Then, once the underpressure condition has been resolved, the fill actuator 1450 may be moved back to the fill mode, returning the valve assembly 2000 to the first state.

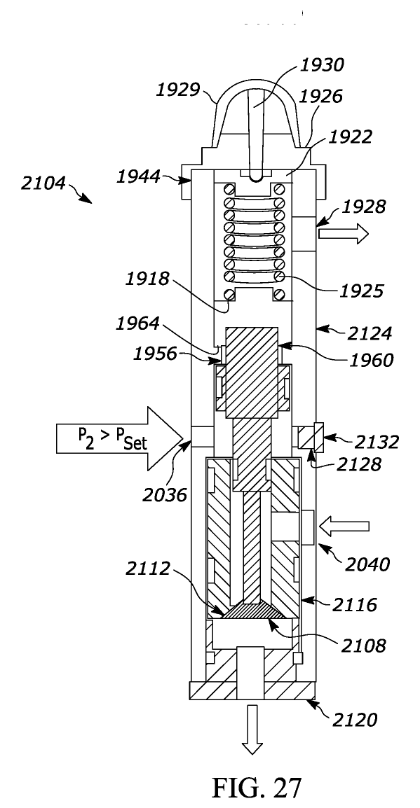

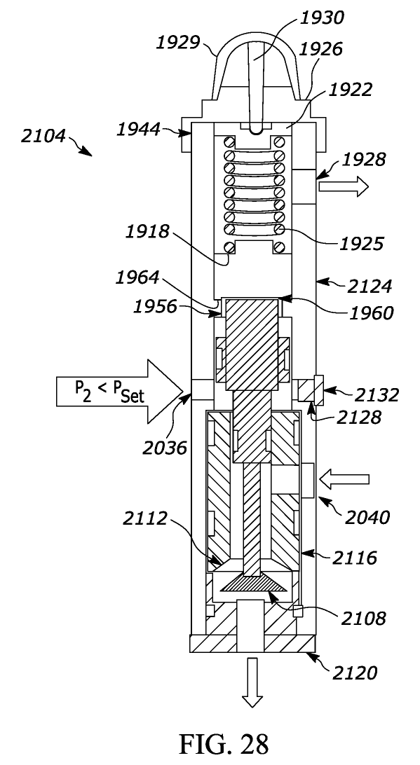

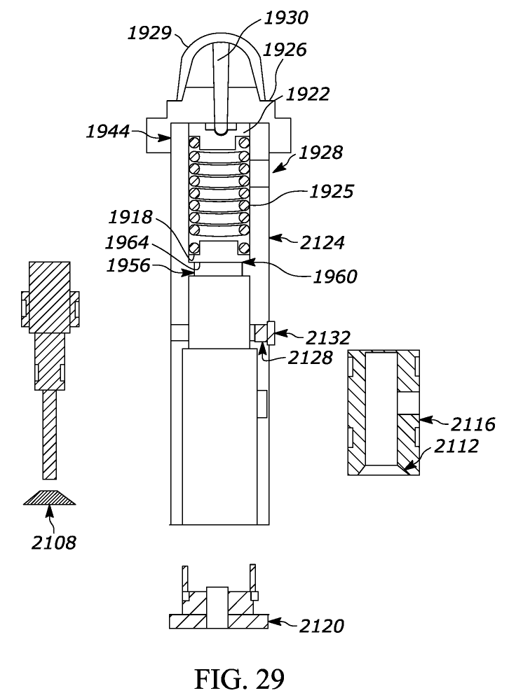

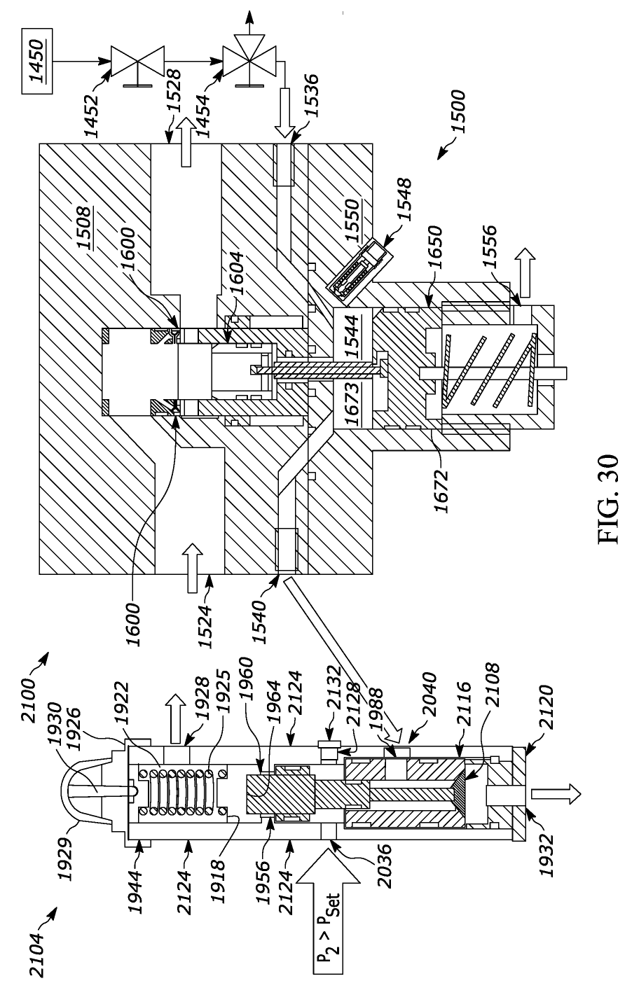

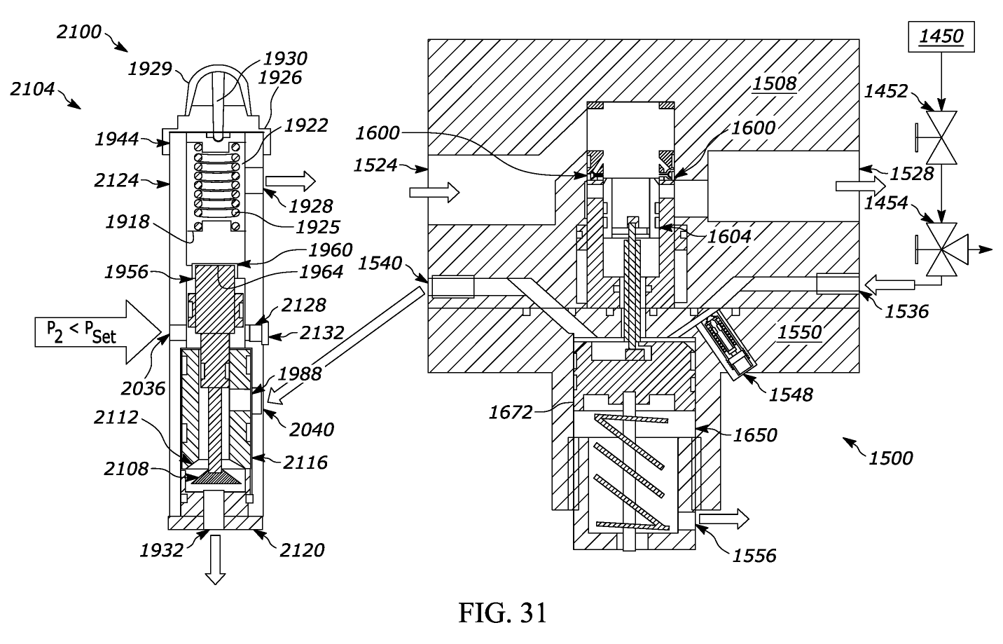

FIGS. 27-29 illustrate another example of a controller 2104 that is constructed in accordance with the teachings of the present disclosure, and FIGS. 30 and 31 illustrate another example of a valve assembly 2100 that is constructed in accordance with the teachings of the present disclosure and includes the valve 1500 coupled to and in fluid communication with the controller 2104. The controller 2104 is substantially similar to the controller 2004 but differs in several respects. First, a control element 2108 that differs from the control element 2012 in that the control element 2108 is a substantially conical disc. Second, the controller 2104 has a controller seat 2112 that differs from the controller seat 1924 in that the controller seat 2112 is integrally formed with the controller sleeve 2116 and the controller seat 2112 shaped to accommodate the different control element 2108. Third, the controller 2104 has a controller plug 2120 that differs from the controller plug 2020 in that the controller plug 2120 is shaped to accommodate the aforementioned changes to the location of the controller seat 2112 and the shape of the control element 2108. Fourth, the controller 2104 has a controller body 2124 that differs from the controller body 1904 in that the controller body 2124 further includes a third vent opening 2128 and a vent plug 2132. The third vent opening 2128 is in fluid communication with the first port 1936 and is disposed between the second port 1940 and the first vent opening 1928; however, one of skill in the art will appreciate that the third vent opening 2128 may be disposed at a different location along the controller body 2124 to accommodate, for example, the controller stem 1908 or the controller sleeve 2116. The vent plug 2132 is removably coupled (e.g., threaded) to the controller body 2124. When the vent plug 2132 is coupled to the controller body 2124, the vent plug 2132 is disposed in the third vent opening 2128, thereby closing the third vent opening 2128 and prohibiting the release of pressure during the detection of the underpressure condition. However, the vent plug 2132 can be removed from the third vent opening 2128 as needed to service the controller 2104. Fifth, and finally, while the controller 2104 has a control spring 2125 that, like the control spring 2025, applies a biasing force on the first spring seat 1918 so as to bias the first spring seat 1918 into contact with the first end 1964 of the controller stem 1908, this biasing force biases the control element 2108 away from the controller seat 2112, towards its open position.

Notwithstanding these differences, the valve assembly 2100 operates in substantially the same manner as the valve assembly 2000. Thus, like the valve assembly 2000, the valve assembly 2100 is movable between a first state (shown in FIG. 30) and a second state (shown in FIG. 31). When the valve assembly 2100 is in the first state, the valve 1500 and the controller 2104 are in their open and closed positions, respectively. With the valve 1500 in its open position, the piston 1650 is subject to the actuator pressure generated by the actuator fluid in the actuator fluid passageway 1544, and the actuator pressure is greater than the force applied by the spring 180. With the controller 2104 in its closed position, the control element 2108 of the controller 2104 is engaged with the controller seat 2112.

As with the valve assembly 2000, the valve assembly 2100 will continue in the first state subject to detection of the downstream underpressure condition. Upon detecting that the downstream pressure decreases and is less than the pre-determined pressure set-point, the valve assembly 2100 will move to the second state. That is, the pressure decrease allows the biasing force applied by the control spring 2125, which is now greater than the force generated by the downstream pressure at the first port 2036, to move the controller stem 1908 of the controller 2104 in a direction towards the second end 1948 of the controller body 2124, which causes the control element 2108 to move in the same direction and out of engagement and away from the controller seat 2112, thereby opening the controller 2104. As illustrated by FIG. 31, when the control element 2108 is spaced apart from the controller seat 2112, the actuator fluid passageway 1544, the actuator fluid outlet 1536, the second port 2040, the sleeve inlet port 1988, the sleeve fluid passageway 1941, and the plug fluid passageway 1921 are in fluid communication with the atmosphere through the second vent opening 1932, which causes the actuator pressure trapped within the first portion 1673 of the piston chamber 1672 to be released by flowing out to the atmosphere through the second vent opening 1932, thereby closing the valve 1500. Then, once the underpressure condition has been resolved, the fill actuator 1450 may be moved back to the fill mode, returning valve assembly 2100 to the first state.

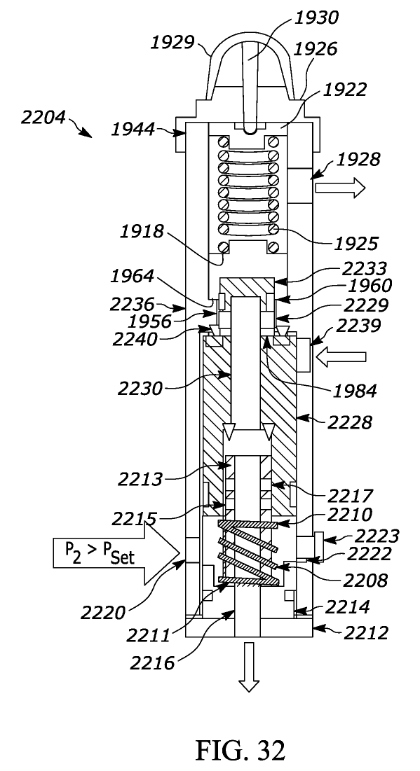

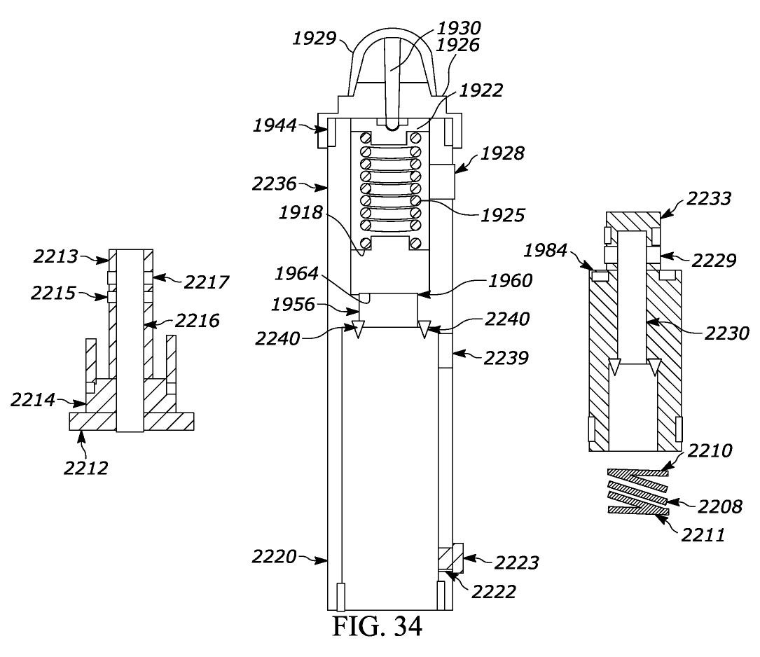

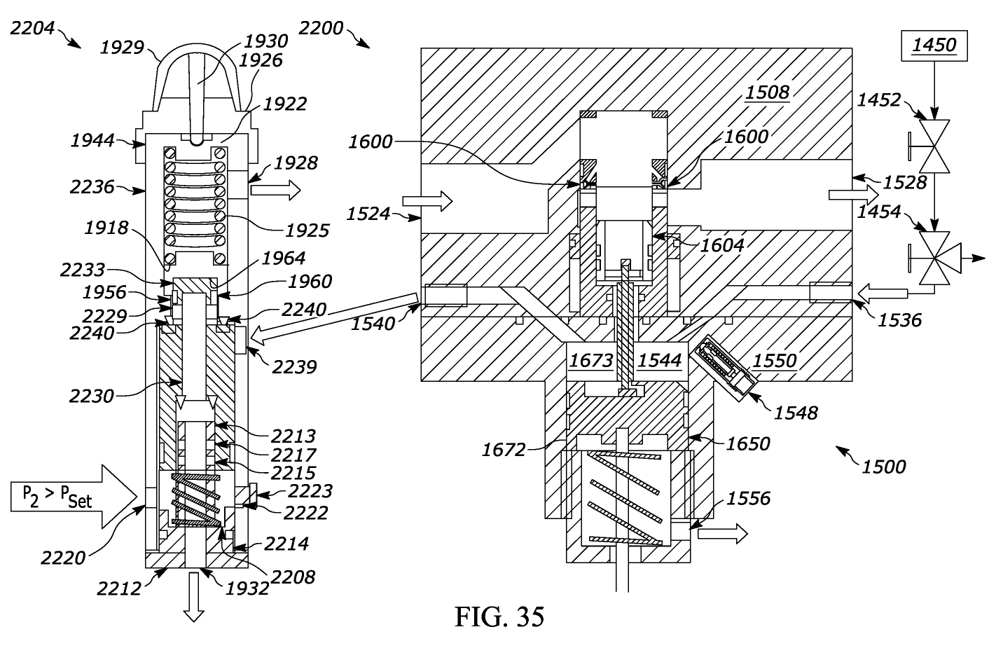

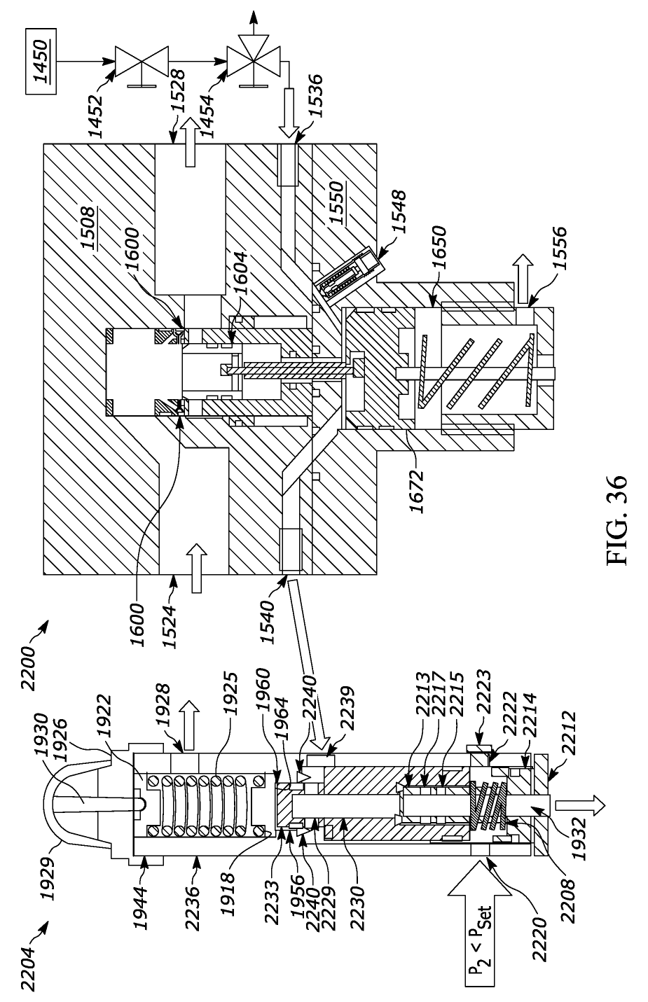

FIGS. 32-34 illustrate another example of a controller 2204 that is constructed in accordance with the teachings of the present disclosure, and FIGS. 35 and 36 illustrate another example of a valve assembly 2200 that is constructed in accordance with the teachings of the present disclosure and includes the valve 1500 coupled to and in fluid communication with the controller 2204. The controller 2204 is substantially similar to the controller 2104, in that the controller 2204 also has a control element 2208, a controller plug 2212, a controller sleeve 2228, a controller body 2236, and a controller seat 2240, but differs in several respects.

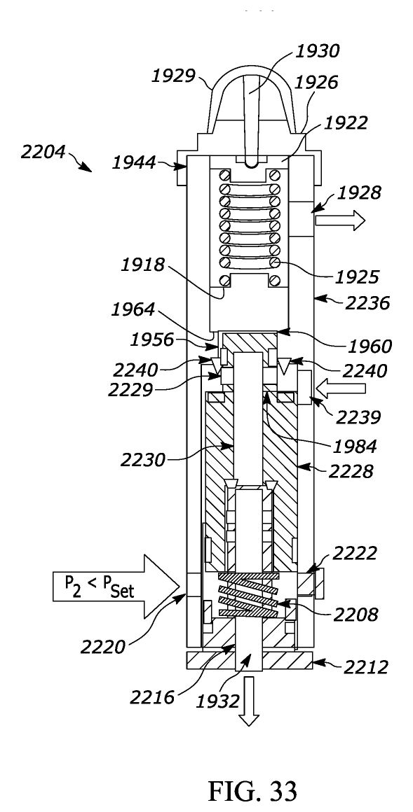

First, unlike the controller 2104, the controller 2204 does not include a controller stem (e.g., the controller stem 1908). Second, the controller plug 2212 differs from the controller plug 2120 in that the controller plug 2212 includes a projection 2213, a plug body 2214, a second sealing element 2215, a plug fluid passageway 2216, and a plug inlet 2217. The projection 2213 is substantially cylindrical and extends away from the of the plug body 2214 of the controller plug 2212; however, one of skill in the art will appreciate that the projection 2213 may have a different shape as needed to accommodate the controller sleeve 2228 and the control element 2208. The second sealing element 2215 is substantially similar to the first sealing element 1996 but differs in that the second sealing element 2215 is disposed on the projection 2213 and intended to sealingly couple the controller plug 2212 to the controller sleeve 2228. The plug fluid passageway 2216 is in fluid communication with the second vent opening 1932 and is substantially similar to the plug fluid passageway 1921, but the plug fluid passageway 2216 differs from the plug fluid passageway 1921 in that the plug fluid passageway 2216 is disposed at least partially in the projection 2213 and plug body 2214 of the controller plug 2212. The plug inlet 2217 is formed at an end of the projection 2213 of the controller plug 2212 and, when the controller 2204 is in operation, allows the second port 2239 of the controller body 2236 to be in fluid communication with the second vent opening 1932, as best illustrated in FIG. 33. Third, the control element 2208 differs from the control element 2108 in that the control element 2208 takes the form of a spring circumferentially arranged around and engaged with the controller plug 2212. As illustrated, the control element 2208 has a first end 2210 engaged with a controller sleeve 2228 and a second end 2211 opposite the first end 2210 and engaged with a portion of the plug body 2214 of the controller plug 2212. The spring 2208 is configured to bias the controller sleeve 2228 in a direction towards the controller seat 2240.

Fourth, the controller 2204 includes a first port 2220, a third vent opening 2222, and a vent plug 2223 that differ from the first port 1936, the third vent opening 2128, and the vent plug 2132, respectively, in that the first port 2216, the third vent opening 2222, and the vent plug 2223 are disposed adjacent to the controller plug 2212. Fifth, the controller body 2236 differs from the controller body 2124 in that the controller body 2236 includes an aperture 2237 and a second ledge 2238 that differ from the aperture 1960 and the second ledge 1956, respectively, to accommodate the controller sleeve 2228 and the second port 2239. Additionally, unlike the controller body 2124, because the controller 2204 does not include a controller stem, the controller body 2236 does not include the first ledge 1952. Moreover, although the second port 2239 is substantially similar to the second port 1940, it differs in that the second port 2239 is disposed adjacent to the second ledge 2238. Sixth, the controller sleeve 2228 differs from the controller sleeve 2116 in that the controller sleeve 2228 has a different shape and size so as to accommodate the different control element 2208 and the different controller plug 2120. Moreover, the controller sleeve 2228, like the controller sleeve 2116, includes a sleeve inlet port 2229 and a sleeve fluid passageway 2230 that are substantially similar to the sleeve inlet port 1988 and the sleeve fluid passageway 1941, but the sleeve inlet port 2229 is further disposed in a projection 2233 extending from the second end 1984 of the controller sleeve 2228. The projection 2233 is substantially cylindrical, disposed within an aperture 2237 of the controller body 2236, and adjacent to the second ledge 2238. Additionally, the controller seat 2240 differs from the controller seat 2112 in that the controller seat 2240 is carried by (e.g., integrally formed with) the second ledge 2238 of the controller body 2236. Finally, while the controller 2204 also has a control spring 2225, the control spring 2225 applies a biasing force on the projection 2233 so as to bias the controller sleeve 2228 away from the controller seat 2240, towards its open position.

Notwithstanding these differences, the valve assembly 2200 operates in a similar manner as the valve assembly 2100. Thus, like the valve assembly 2100, the valve assembly 2200 is movable between a first state (shown in FIG. 35) and a second state (shown in FIG. 36). When the valve assembly 2200 is in the first state, the valve 1500 and the controller 2204 are in their open and closed positions, respectively. With the valve 1500 in its open position, the piston 1650 is subject to the actuator pressure generated by the actuator fluid in the actuator fluid passageway, and the actuator pressure generates a force that is greater than the force applied by the spring 1800. Meanwhile, with the controller 2204 in its closed position, the sleeve 2228 of the controller 2204 is engaged with the controller seat 2240 (and the spring 2208 biases the sleeve 2228 into this engagement with the controller seat 2240).

As with the valve assembly 2100, the valve assembly 2200 will continue in the first state subject to detection of the downstream underpressure condition. Upon detecting (via the first port 2220) that the downstream pressure decreases and is less than the pre-determined pressure set point, the valve assembly 2200 will move to the second state. That is, the pressure decrease allows the biasing force applied by the control spring 2225, which is now greater than the (upward) force generated by the downstream pressure at the first port 2220 and the (upward) force applied by the spring 1800), to cause the controller sleeve 2228 to move in a direction (downward in the present example) towards the controller plug 2212. This, in turn, causes the controller sleeve 2228 to move out of engagement and away from the controller seat 2240 and compresses the control element 2208, thereby opening the controller 2204. As illustrated by FIG. 36, when the controller sleeve 2228 is spaced apart from the controller seat 2240, the actuator fluid passageway 1544, the actuator fluid outlet 1940, the second port 2239, the sleeve inlet port 2229, the sleeve fluid passageway 2230, and the plug fluid passageway 2216 are in fluid communication with the atmosphere through the second vent opening 1932, which causes the actuator pressure trapped within the first portion 1673 of the piston chamber 1672 to be released by flowing out to the atmosphere through the second vent opening 1932, thereby closing the valve 1500. Then, once the underpressure condition has been resolved, the fill actuator 1450 may be moved back to the fill mode, returning the valve assembly 2200 to the first state.

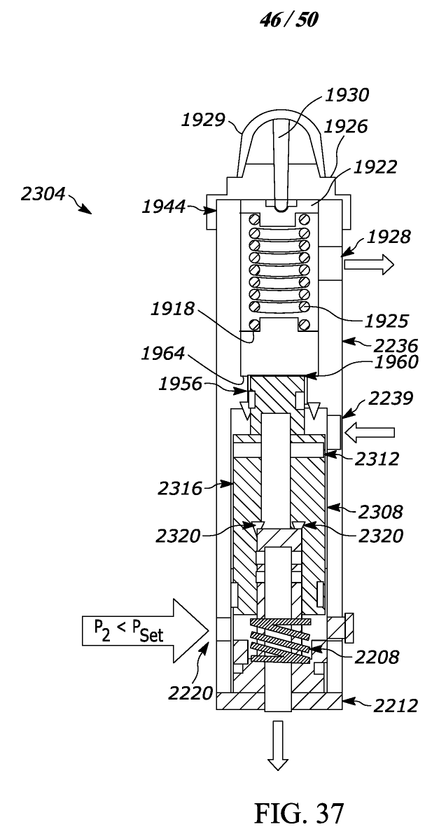

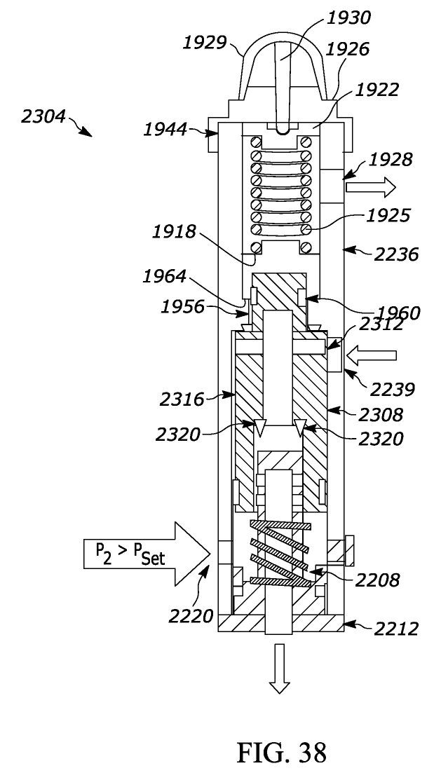

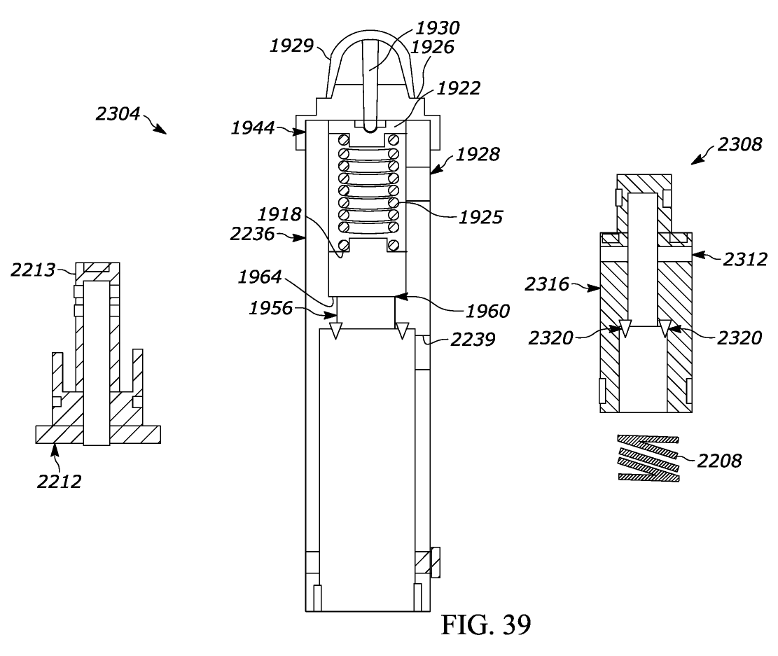

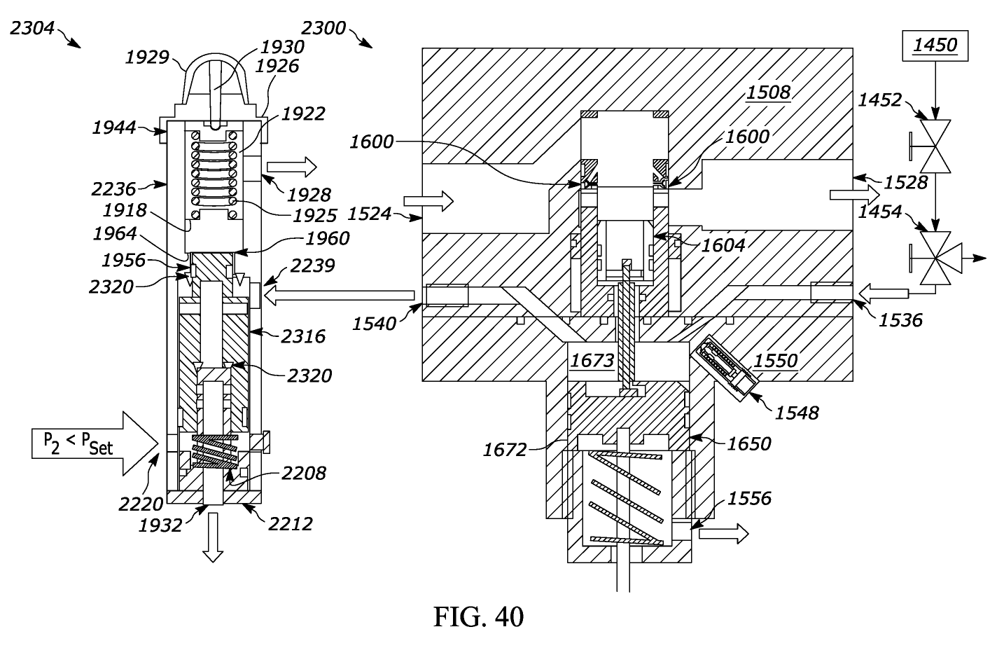

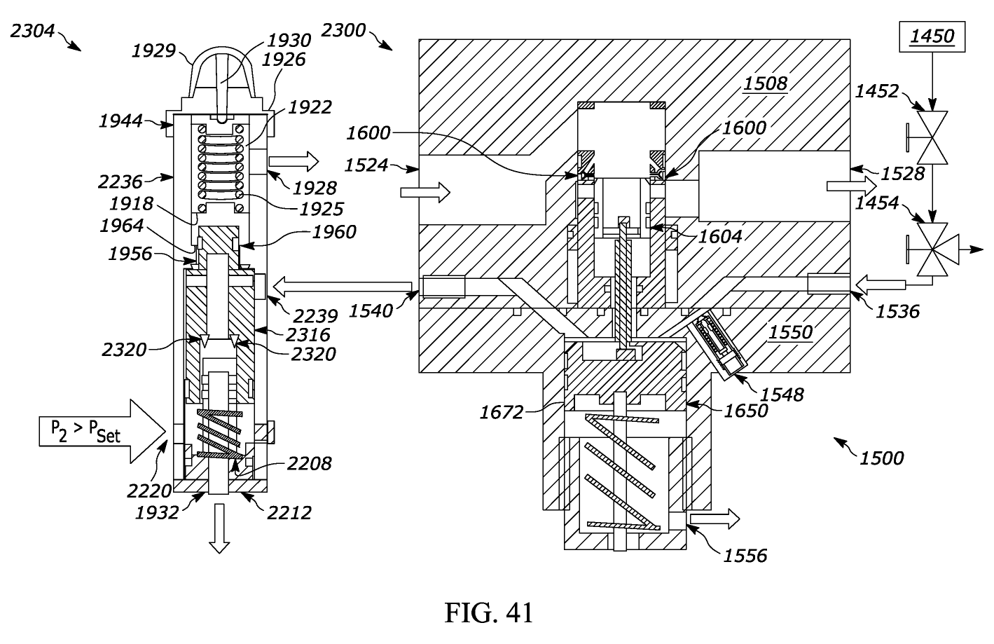

FIGS. 37-39 illustrate another example of a controller 2304 that is constructed in accordance with the teachings of the present disclosure, and FIGS. 40 and 41 illustrate another example of a valve assembly 2300 that is constructed in accordance with the teachings of the present disclosure and includes the valve 1500 coupled to and in fluid communication with the controller 2304. The controller 2304 is substantially similar to the controller 2204 but differs in several respects. First, while the controller 2304 includes a controller sleeve 2308 including a sleeve inlet port 2312 that is substantially similar to the sleeve inlet port 2229, the controller sleeve 2308 differs from the controller sleeve 2228 in that the sleeve inlet port 2312 is disposed in the sleeve body 2316 (adjacent to the projection 2233, rather than in the projection itself) and in fluid communication with the sleeve fluid passageway 2230 and the second port 2239. Second, the controller 2304 includes a controller seat 2320 that differs from the controller seat 2240 in that the controller seat 2320 is carried by (e.g., integrally formed with) the sleeve body 2316. Third, the controller 2304 controls the valve 1500 responsive to detection of an overpressure condition (i.e., a pressure that is greater than a pre-determined pressure set point of the controller 2304) downstream of the valve 1500 via the second port 2239 of the controller 2304. Fourth, and finally, while the controller 2304 also has a control spring 2325 that likewise applies a biasing force on the projection 2233, the biasing force biases the controller sleeve 2308 (and the controller seat 2320 carried by the sleeve body 2316) toward the controller plug 2212.

Notwithstanding these differences, the valve assembly 2300 operates in substantially the same manner to the valve assembly 2200, albeit in response to detection of an overpressure condition rather than an underpressure condition. Thus, like the valve assembly 2200, the valve assembly 2300 is movable between a first state (shown in FIG. 40) and a second state (shown in FIG. 41). When the valve assembly 2300 is in the first state, the valve 1500 and the controller 2304 are in their open and closed positions, respectively. With the valve 1500 in its open position, the piston 1650 is subject to the actuator pressure generated by the actuator fluid in the actuator fluid passageway, and the actuator pressure generates a force that is greater than the force applied by the spring 1800. Meanwhile, with the controller 2304 in its closed position, the controller plug 2212 of the controller 2304 is engaged with the controller seat 2320 (and the control spring 2325 biases the controller seat 2320 into engagement with the controller plug 2212). More particularly, the projection 2213 of the controller plug 2212 engages the controller seat 2320.

As with the valve assembly 2200, the valve assembly 2300 will continue in the first state subject to detection of the downstream overpressure condition. Upon detecting (via the first port 2220) that the downstream pressure increases and is greater than the pre-determined pressure se point, the valve assembly 2300 will move to the second state. That is, the pressure increase causes the force generated by the downstream pressure detected by the first port 2220 to overcome the biasing force generated by the control spring 2325, which thereby causes the piston sleeve 2316 to move in a direction (upward in the present example) away from the controller plug 2212 (specifically the projection 2213), which causes the controller seat 2320 (carried by the piston sleeve 2316 in the present example) to move out of engagement and away from the controller plug 2212 (specifically the projection 2213). This, in turn, opens the controller 2304. As illustrated by FIG. 41, when the projection 2213 is spaced apart from the controller seat 2320, the actuator fluid passageway 1544, the actuator fluid outlet 1940, the second port 2239, the sleeve inlet port 2312, the sleeve fluid passageway 2230, and the plug fluid passageway 2216 are in fluid communication with the atmosphere through the second vent opening 1932, which causes the actuator pressure within the first portion 1673 of the piston chamber 1672 to be released by flowing out to the atmosphere through the second vent opening 1932, thereby closing the valve 1500. Then, once the overpressure condition has been resolved, the fill actuator 1450 may be moved back to the fill mode, returning the valve assembly 2300 to the first state.

Optionally, any of the valves described herein can include one or more sensors that help to detect movement of various components of the valves. For example, any of the slam-shut valves described herein can include one or more sensors mounted to a plug (e.g., plug 1604), a piston (e.g., piston 1650), or a valve stem (e.g., valve stem 1700) that help to determine the position of that/those component(s), which can in turn help to determine whether the slam-shut valve is in its open position or its closed position. Likewise, any of the controllers described herein can include one or more sensors mounted to a controller stem (e.g., controller stem 1908), a controller sleeve (e.g., controller sleeve 1916), or a controller plug (e.g., controller plug 1920) that help to determine the position of that/those component(s), which can in turn help to determine whether the controller is in its open position or its closed position, which can in turn help to identify tripping events (i.e., overpressure or underpressure conditions).

Preferred embodiments of this invention are described herein, including the best mode or modes known to the inventors for carrying out the invention. Although numerous examples are shown and described herein, those of skill in the art will readily understand that details of the various embodiments need not be mutually exclusive. Instead, those of skill in the art upon reading the teachings herein should be able to combine one or more features of one embodiment with one or more features of the remaining embodiments. Further, it also should be understood that the illustrated embodiments are exemplary only and should not be taken as limiting the scope of the invention. The use of any and all examples, or exemplary language (e.g., “such as”) provided herein, is intended merely to better illuminate the aspects of the exemplary embodiment or embodiments of the invention, and do not pose a limitation on the scope of the invention. No language in the specification should be construed as indicating any non-claimed element as essential to the practice of the invention.

1. A slam-shut device, comprising:
a valve body comprising a valve inlet, a valve outlet, and a valve fluid flow passageway connecting the valve inlet to the valve outlet;
a valve trim assembly, comprising:
a valve seat disposed in the valve fluid flow passageway of the valve body;
a valve plug movable relative to the valve seat to control fluid flow through the valve fluid flow passageway, the valve plug comprising a plug body having first end and a second end opposite the first end, a plug plate disposed in the plug body between the first end and the second end, a balancing port formed through the plug plate and fluidly connecting the first end and the second end, a ledge disposed immediately adjacent the first end, and a plug groove formed between the plug plate and the ledge;
a piston comprising a piston body having a first end and a second end opposite the first end, a ledge disposed immediately adjacent the first end, and a piston groove formed in the piston body, the piston groove partially defined by the ledge; and
a valve stem coupled to the valve plug and to the piston, the valve stem having a first end and a second opposite the first end, the first end securely disposed in the plug groove, and the second end securely disposed in the piston groove;
an actuator coupled to the valve body, the actuator comprising a piston chamber, wherein the piston is movably disposed in the piston chamber; and
a spring having one end seated against the piston and the other end seated against the actuator, the spring configured to bias the valve plug relative to the valve seat.

2. The slam-shut device of claim 1, wherein the spring is configured to bias the valve plug into contact with the valve seat.

3. The slam-shut device of claim 1, further comprising a relief valve removably coupled to the actuator, the relief valve configured to selectively relieve the piston chamber.

4. The slam-shut device of claim 1, further comprising an actuator inlet at least partially formed in the actuator and an actuator fluidly connected to the piston chamber via the actuator inlet.

5. A controller for a slam-shut device, comprising:
a controller body comprising a first port and a second port, the first port adapted to be in fluid communication with a pressure downstream of the slam-shut device, and the second port adapted to be in fluid communication with an actuator outlet of the slam-shut device;
a control element;
a controller sleeve disposed in the controller body, the controller sleeve comprising a sleeve port configured to be in fluid communication with the second port of the controller body; and
a controller seat at least partially disposed within the controller body,
wherein the control element is movable within the controller body relative to the controller seat between a first position and a second position responsive to a downstream overpressure condition or underpressure condition detected via the first port, thereby closing the slam-shut device via the second port.

6. The controller of claim 5, further comprising a controller stem movably disposed in the controller body and coupled to the control element to move the control element between the first position and the second position.

7. The controller of claim 6, wherein in one of the first and second positions the control element is engaged with the controller seat and in the other of the first and second positions the control element is spaced apart from the controller seat.

8. The controller of claim 6, wherein the controller stem is movably disposed in the controller body, and wherein the control element comprises a disc coupled to an end of the controller stem.

9. The controller of claim 5, wherein the control element comprises a spring coupled to the controller sleeve and the controller seat.

10. The controller of claim 5, wherein the controller sleeve is movable within the controller body relative to the controller seat between a first position and a second position responsive to the downstream overpressure condition or underpressure condition.

11. The controller of claim 10 wherein in one of the first and second positions the controller sleeve is engaged with the controller seat and in the other of the first and second positions the controller sleeve is spaced apart from the controller seat.

12. The controller of claim 5, further comprising a controller plug coupled to the controller sleeve, the controller seat integrally formed with the controller plug.

13. The controller of claim 5, wherein the controller seat is carried by the controller sleeve.

14. A slam-shut device assembly, comprising:
a slam-shut valve, comprising:
a valve body comprising a valve inlet, a valve outlet, and a valve fluid flow passageway connecting the valve inlet to the valve outlet;
a valve trim assembly, comprising:
a valve seat disposed in the valve fluid flow passageway of the valve body;
a valve plug movable relative to the valve seat to control fluid flow through the valve fluid passageway, the valve plug comprising a plug body and a plug groove formed in the plug body;
a piston comprising a piston body and a piston groove formed in the piston body; and
a valve stem coupled to the valve plug and to the piston, the valve stem having a first end and a second opposite the first end, the first end securely disposed in the plug groove, and the second end securely disposed in the piston groove;
an actuator coupled to the valve body, the actuator comprising a piston chamber, wherein the piston is movably disposed in the piston chamber; and
a spring configured to bias the valve plug relative to the valve seat;
a controller coupled to the slam-shut device for selectively closing the slam-shut device, the controller comprising:
a controller body comprising a first port and a second port, the first port adapted to be in fluid communication with a pressure downstream of the slam-shut device, and the second port adapted to be in fluid communication with an actuator outlet of the slam-shut device;
a control element;
a controller sleeve disposed in the controller body, the controller sleeve comprising a sleeve port adapted to be in fluid connection with the second port of the controller body; and
a controller seat coupled to the controller body,
wherein the control element is movable within the controller body relative to the controller seat between a first position and a second position responsive to an overpressure condition or underpressure condition detected via the first port, thereby closing the slam-shut device via the second port.

15. The slam-shut assembly of claim 14, wherein the controller further comprises a controller stem movably disposed in the controller body and coupled to the control element to move the control element between the first position and the second position.

16. The slam-shut assembly of claim 14, wherein the spring is configured to bias the valve plug into contact with the valve seat.

17. The slam-shut assembly of claim 14, further comprising a relief valve coupled to the actuator, the relief valve configured to selectively relieve the piston chamber.

18. The slam-shut assembly of claim 17, wherein the relief valve has a body, a seat, an arm movable relative to the seat within the body, and a plug carried by an end of the arm, and wherein the relief valve is movable between a first position, in which the plug of the relief valve is seated against the seat of the relief valve, and a second position, in which the plug of the relief valve is spaced from the seat of the relief valve, thereby relieving the piston chamber.

19. The slam-shut assembly of claim 14, wherein the controller sleeve is movable within the controller body between a first position and a second position responsive to an overpressure condition or underpressure condition in the first port.

20. The slam-shut assembly of claim 14, wherein the controller further comprises a controller plug coupled to the controller sleeve, the controller seat integrally formed with the controller plug.
